(19) United States
(12) Patent Application Publication
(10) Pub. No.: US 2023/0244646 A1
(43) Pub. Date: Aug. 3, 2023

(54) INFORMATION PROCESSING METHOD AND INFORMATION PROCESSING SYSTEM

(71) Applicant: YAMAHA CORPORATION, Hamamatsu-shi (JP)

(72) Inventors: Ryunosuke DAIDO, Hamamatsu-shi (JP); Keijiro SAINO, Hamamatsu-shi (JP); Masahiro SHIMIZU, Hamamatsu-shi (JP)

(21) Appl. No.: 18/295,869

(22) Filed: Apr. 5, 2023

Related U.S. Application Data
(63) Continuation of application No. PCT/JP20/37965, filed on Oct. 7, 2020.

(51) Int. Cl. G06F 16/21; G06F 16/64

(52) U.S. Cl. CPC G06F 16/219; G06F 16/64

(57) ABSTRACT

First time-series data is edited according to a first user instruction, and second time-series data representing a series of features and generated based on the edited first time-series data is edited according to a second user instruction. In response to editing of the first time-series data, the edited first time-series data is saved as a new version in first history data. In response to editing of the second time-series data, the edited second time-series data is saved as a new version in second history data. A first version number and a second version number are designated according to a third user instruction. Third time-series data representing content corresponding to the first time-series data is then generated by using the first version of first time-series data in the first history data, and the second version of second time-series data in the second history data.

### CROSS REFERENCE TO RELATED APPLICATIONS

This application is a Continuation application of PCT Application No. PCT/JP2020/037965, filed on Oct. 7, 2020, the entire content of which is incorporated herein by reference.

### TECHNICAL FIELD

The present disclosure relates to processing of time-series data.

### BACKGROUND

Various voice synthesis techniques have been proposed for synthesizing a voice based on phonetic symbols. For example, Japanese Patent Application Laid-Open Publication 2016-90916 discloses a technique for synthesizing a singing voice of sung sounds comprising a sequence of notes and phonetic symbols that are indicated by a user on an editing screen. The editing screen is a piano roll screen that includes a time axis and a pitch axis. The user designates a phonetic symbol (text to be sounded), along with pitches and durations of notes, which together constitute a piece of music.

To synthesize a voice in such a way that accurately reflects a user's intention, the user is required to edit voice synthesis conditions (e.g., various parameters), listen to a resulting sound, and repeat the process using trial and error until a desired result is obtained. To carry out the process, the user needs to be able to cancel a latest edit (Undo) or re-execute the canceled edit (Redo), from among a plurality of edits. However, in practice, use of simple Undos or Redos and comparing outcomes of various edits to obtain a desired result is difficult. The problem discussed above relates to voice synthesis, but may arise in various situations in which time-series data is generated.

### SUMMARY

In view of the above circumstances, an object of the present disclosure is to facilitate generation of time-series data that accords with an intention of a user.

To solve the problem discussed above, an information processing method according to an aspect of the present disclosure includes: editing first time-series data in accordance with a first instruction provided by a user; generating, based on the edited first time-series data, second time-series data representative of a series of features that corresponds to the edited first time-series data; editing the second time-series data in accordance with a second instruction provided by the user; in response to editing of the first time-series data, saving the edited first time-series data, as a new version of first time-series data in first history data, while incrementing a first version number indicative of a version of the edited first time-series data, and initializing a second version number indicative of a version of the second time-series data generated based on the edited first time-series data; in response to editing of the second time-series data, saving the edited second time-series data, as a new version of second time-series data in second history data, while incrementing the second version number and retaining the first version number; in response to a third instruction provided by the user, designating a first version number from among a plurality of values of the first version number and a second version number from among a plurality of values of the second version number according to the third instruction; and generating third time-series data representative of audio content corresponding to the first time-series data using (i) a first version of first time-series data in the first history data wherein the first version is indicated by the first version number of a first value, and (ii) a second version of second time-series data in the second history data wherein the second version is indicated by the first version number of the first value and the second version number of a second value.

In another aspect, an information processing system includes: one or more memories configured to store instructions; and one or more processors configured to execute the stored instructions to perform a method including: editing first time-series data in accordance with a first instruction provided by a user; generating, based on the edited first time-series data, second time-series data representative of a series of features that corresponds to the edited first time-series data; editing the second time-series data in accordance with a second instruction provided by the user; in response to editing of the first time-series data, saving the edited first time-series data, as a new version of first time-series data in first history data, while incrementing the first version number, and initializing the second version number; and in response to editing of the second time-series data, saving the edited second time-series data, as a new version of second time-series data in second history data while incrementing the second version number and retaining the first version number; in response to a third instruction provided by the user, designating a first version number from among a plurality of values of the first version number and a second version number from among a plurality of values of the second version number according to the third instruction; and generating third time-series data representative of audio content corresponding to the first time-series data using (i) a first version of first time-series data in the first history data wherein the first version is indicated by the first version number of a first value and (ii) a second version of second time-series data in the second history data wherein the second version is indicated by the first version number of the first value and the second version number of a second value.

In still another aspect, an information processing method includes: editing first time-series data in accordance with a first instruction provided by a user; generating, based on the edited first time-series data, second time-series data representative of a series of features that corresponds to the edited first time-series data; editing the second time-series data in accordance with a second instruction provided by the user; in response to editing of the first time-series data, saving the edited first time-series data in first history data; in response to editing of the second time-series data, saving the edited second time-series data in second history data; and generating third time-series data representative of content corresponding to the first time-series data using (i) a first version of first time-series data in the first history data, and (ii) a second version of second time-series data in the second history data.

### BRIEF DESCRIPTION OF THE DRAWINGS

FIG. 1 is a block diagram illustrating a configuration of an information processing system according to a first embodiment.

FIG. 2 is a schematic diagram of an editing screen.

FIG. 3 is a block diagram showing an example functional configuration of the information processing system.

FIG. 4 is a flowchart illustrating a procedure of a first editing process.

FIG. 5 is a flowchart illustrating a procedure of a second editing process.

FIG. 6 is a flowchart illustrating a procedure of a third editing process.

FIG. 7 is an explanatory view of a data structure in a history area.

FIG. 8 is a flowchart illustrating a procedure of a first control process.

FIG. 9 is a flowchart illustrating a procedure of a second control process.

FIG. 10 is a flowchart illustrating a procedure of a third control process.

FIG. 11 is a schematic diagram of an editing screen according to a second embodiment.

FIG. 12 is a block diagram showing an example of a functional configuration of an information processing system according to the second embodiment.

FIG. 13 is an explanatory diagram of a data structure in a history area according to the second embodiment.

FIG. 14 is a schematic diagram of a comparison screen.

FIG. 15 is an explanatory diagram of a synthesis sound according to a third embodiment.

FIG. 16 is a schematic diagram of an editing screen according to the third embodiment.

FIG. 17 is a schematic diagram of an editing screen according to a modification.

### DETAILED DESCRIPTION OF THE EMBODIMENTS

### A: First Embodiment

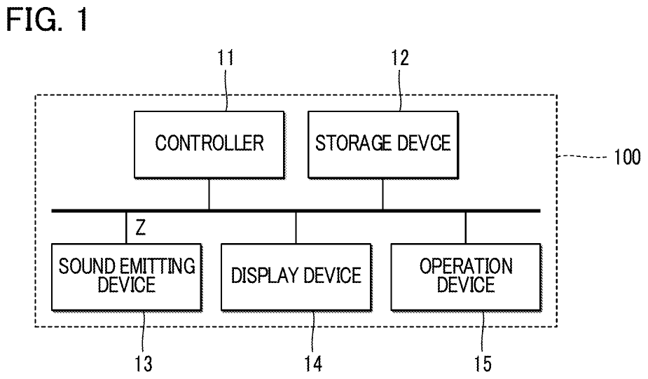

FIG. 1 is a block diagram illustrating a configuration of an information processing system 100 according to a first embodiment of this disclosure. The information processing system 100 is an audio processing system that generates audio signals Z. An audio signal Z is a time domain signal representative of a waveform of a synthesis sound. The synthesis sound is, for example, an instrumental sound produced by a musical instrument played by a virtual player, or a singing sound produced by a virtual singer singing a piece of music.

The information processing system 100 is implemented by a computer system that includes a controller 11, a storage device 12, a sound emitting device 13, a display device 14, and an operation device 15. The information processing system 100 is realized by an information apparatus, such as a smartphone, a tablet terminal, or a personal computer. The information processing system 100 may be realized not only by a single apparatus but also by a plurality of mutually separate apparatuses (e.g., a client-server system).

The controller 11 comprises one processor or multiple processors that control each element of the information processing system 100. Specifically, the controller 11 comprises one or more types of processors, such as a Central Processing Unit (CPU), a Sound Processing Unit (SPU), a Digital Signal Processor (DSP), a Field Programmable Gate Array (FPGA), or an Application Specific Integrated Circuit (ASIC). The controller 11 executes various processes for generating audio signals Z.

The storage device 12 comprises one memory or multiple memories that store programs executed by the controller 11 and various types of data used by the controller 11. The storage device 12 comprises a known recording medium, such as a magnetic recording medium or a semiconductor recording medium. The storage device 12 may be constituted of a combination of more than one type of recording media. Further, a portable recording medium detachable from the information processing system 100 or a recording medium (e.g., cloud storage) that can be written to and read from via a communication network may be used as the storage device 12.

The sound emitting device 13 produces synthesis sound represented by audio signals Z generated by the controller 11. The sound emitting device 13 may be a loudspeaker or headphones. For convenience of explanation, a D/A converter that converts audio signals Z from digital to analog and an amplifier that amplifies audio signals Z are not shown. FIG. 1 shows a configuration in which the sound emitting device 13 is mounted to the information processing system 100. However, the sound emitting device 13 may be provided separate from the information processing system 100 and connected to the information processing system 100 either by wire or wirelessly.

The display device 14 displays an image under control of the controller 11. The display device 14 may be a display panel, such as a liquid crystal panel or an organic electro-luminescence panel. The operation device 15 receives instructions from a user. The operation device 15 may comprise multiple controls that are operated by a user, or a touch panel that detects contact by a user. The user designates synthesis sound conditions by operating the operation device 15. The display device 14 displays an image (hereafter, “editing screen”) G that is viewed by the user when designating synthesis sound conditions.

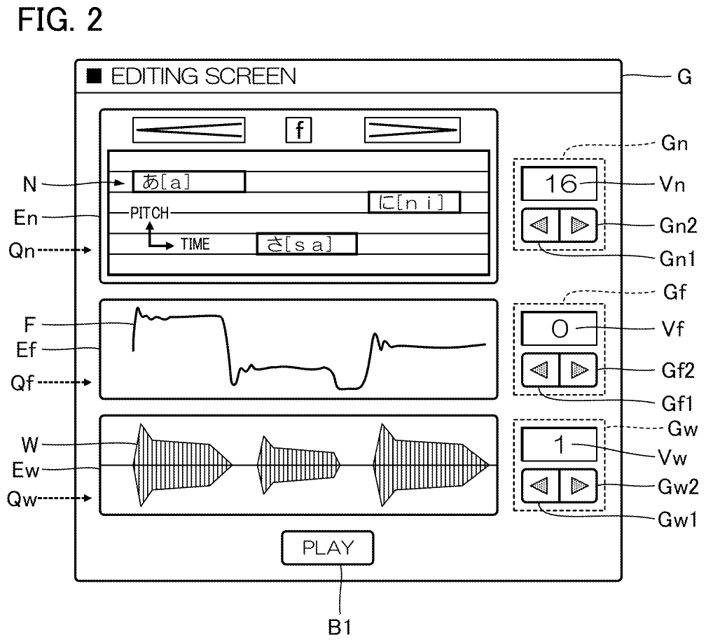

FIG. 2 is a schematic diagram of the editing screen G. The editing screen G includes a plurality of editing areas E (En, Ef, and Ew). The editing areas E have a common time axis (horizontal axis). The editing screen G displays a section of the synthesis sound, and the displayed section changes in accordance with an instruction provided by the user via the operation device 15.

Displayed in the editing area En is a series of notes (hereafter, “note sequence”) N that constitute a musical score of a synthesis sound. A coordinate plane defined by the time axis and a pitch axis (vertical axis) is set in the editing area En. Images representing notes that constitute the note sequence N are arranged in the editing area En. A pitch (e.g., a note number) and a duration are specified for each note of the note sequence N. In a case in which the synthesis sound is a singing sound, a phonetic symbol is specified for each note. The editing area En also displays musical symbols, such as Crescendo, Forte, or Decrescendo. The user provides an edit instruction Qn to the editing area En by operating the operation device 15. The edit instruction Qn is an instruction to edit the note sequence N. More specifically, the edit instruction Qn is an instruction to add a note to or delete a note from the note sequence N, an instruction to change a condition (pitch, duration, or phonetic symbol) of a note, or an instruction to change a musical symbol.

In the editing area Ef, a series of features or feature values (hereafter, “feature sequence”) F of the synthesis sound is displayed. The feature is an acoustic feature of the synthesis sound. Specifically, when the feature of the synthesis sound is a fundamental frequency (pitch), the feature sequence F (i.e., a temporal transition of the fundamental frequency) is displayed in the editing area Ef. The user provides an edit instruction Qf to the editing area Ef by operating the operation device 15. The edit instruction Qf is an instruction to edit the feature sequence F. Specifically, the edit instruction Qf is, for example, an instruction to modify the temporal transition of the feature in a user desired section of the feature sequence F displayed in the editing area Ef.

A waveform W of the synthesis sound along the timeline is displayed in the editing area Ew. The user provides an edit instruction Qw to the editing area Ew by operating the operation device 15. The edit instruction Qw is an instruction to edit the waveform W. Specifically, the edit instruction Qw is an instruction to modify a waveform in a user desired section of the waveform W displayed in the editing area Ew.

In addition to the editing areas E discussed above, the editing screen G includes a plurality of areas (Gn, Gf, and Gw) corresponding to the different editing areas E, and also an icon B1 (PLAY). The icon B1 is a software button operable by a user via the operation device 15. Specifically, the icon B1 is a control for operation by the user to provide an instruction to play the synthesis sound. When the user operates the icon B1, the synthesis sound of the waveform W displayed in the editing area Ew is produced by the sound emitting device 13.

The area Gn is an area for the note sequence N. Specifically, a note sequence version number Vn, an icon Gn1 and an icon Gn2 are displayed in the area Gn. The note sequence version number Vn indicates the version of the note sequence N displayed in the editing area En. The note sequence version number Vn is incremented by 1 each time the note sequence N is edited in accordance with an edit instruction Qn. The user can change the note sequence version number Vn in the area Gn to a desired value by operating the operation device 15. Of the different versions of the note sequence N generated in previous editing processes, a note sequence N of a version that corresponds to the note sequence version number Vn changed by the user is displayed in the editing area En.

The icon Gn1 and the icon Gn2 are software buttons operable by the user of the operation device 15. The icon Gn1 is a control for operation by the user to provide an instruction to revert a note sequence N to a state immediately before a previous edit (i.e., Undo). Specifically, when the user operates the icon Gn1, the note sequence version number Vn changes to a previous value, and the note sequence N of the version corresponding to the note sequence version number Vn after the change is displayed in the editing area En. Accordingly, the icon Gn1 is also expressed as a control for reversing the note sequence version number Vn to the previous value (i.e., canceling a previous edit of the note sequence N). The icon Gn2 is a control for operation by the user to provide an instruction to re-execute the edit canceled by the operation of the icon Gn1 (i.e., Redo).

The area Gf is an area for the feature sequence F. Specifically, a feature sequence version number Vf, an icon Gf1, and an icon Gf2 are displayed in the area Gf. The feature sequence version number Vf indicates the version of the feature sequence F displayed in the editing area Ef. The feature sequence version number Vf is incremented by 1 each time the feature sequence F is edited in accordance with an edit instruction Qf. Further, the user can change the feature sequence version number Vf in the area Gf to a desired value by operating the operation device 15. Of the different versions of the feature sequence F generated in the previous editing processes, a feature sequence F of a version that corresponds to the feature sequence version number Vf changed by the user is displayed in the editing area Ef.

The icon Gf1 and the icon Gf2 are software buttons operable by a user via the operation device 15. The icon Gf1 is operated by the user to provide an instruction to revert a feature sequence F to a state immediately before a previous edit (i.e., Undo). Specifically, when the user operates the icon Gf1, the feature sequence version number Vf changes to the previous value, and a feature sequence F of a version that corresponds to the feature sequence version number Vf changed by the user is displayed in the editing area Ef. Accordingly, the icon Gf1 is also expressed as a control for reversing the feature sequence version number Vf to a previous value (i.e., canceling the previous edit of the feature sequence F). The icon Gf2 is a control for operation by the user to provide an instruction to re-execute the edit canceled by operating the icon Gf1 (i.e., Redo).

The area Gw is an area for the waveform W. Specifically, a waveform version number Vw, an icon Gw1, and an icon Gw2 are displayed in the area Gw. The waveform version number Vw indicates the version of the waveform W displayed in the editing area Ew. The waveform version number Vw is incremented by 1 each time the waveform W is edited in accordance with an edit instruction Qw. The user can change the waveform version number Vw in the area Gw to a desired value by operating the operation device 15. Of the plurality of versions of the waveform W generated in previous editing processes, a waveform W of the version that corresponds to the waveform version number Vw changed by the user is displayed in the editing area Ew.

The icon Gw1 and the icon Gw2 are software buttons operable by the user via the operation device 15. The icon Gw1 is a control operable by the user to provide an instruction to revert a waveform W to a state immediately before a previous edit (i.e., Undo). Specifically, when the user operates the icon Gw1, the waveform version number Vw changes to the previous value, and a waveform W of the version that corresponds to the waveform version number Vw after the change is displayed in the editing area Ew. Accordingly, the icon Gw1 is also expressed as a control for reversing the waveform version number Vw to the previous value (i.e., canceling the previous edit of the waveform W). The icon Gw2 is a control for operation by the user to input an instruction to re-execute the edit canceled by operating the icon Gw1 (i.e., Redo).

As discussed above, in the first embodiment, the version numbers V (Vn, Vf, Vw) are used. Incrementing each version number means progressing an edit, and decrementing of each version number means reversing an edit.

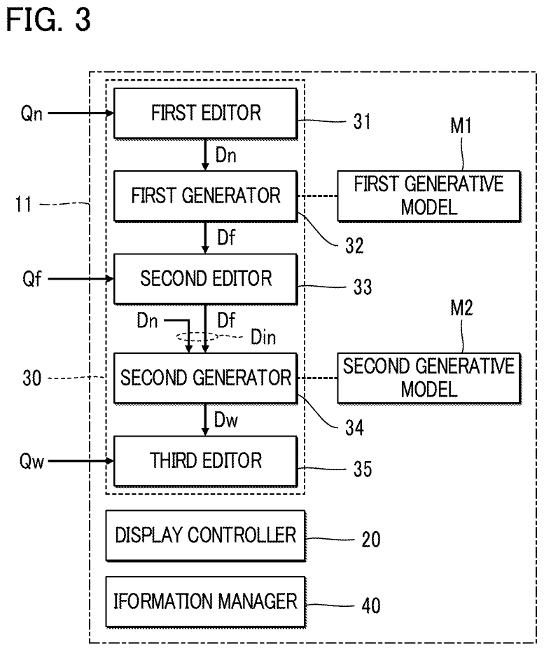

FIG. 3 is a block diagram showing an example of a functional configuration of the information processing system 100. The controller 11 realizes functions (a display controller 20, an editing processor 30, and an information manager 40) for editing conditions of a synthesis sound and generating audio signals Z by executing programs stored in the storage device 12. The display controller 20 displays an image on the display device 14 under control of the controller 11. For example, the display controller 20 causes the display device 14 to display the editing screen G illustrated in FIG. 2. In addition, the display controller 20 updates the editing screen G in response to an instruction (Qn, Qf, or Qw) provided by the user.

The editing processor 30 in FIG. 3 edits the conditions of the synthesis sound (note sequence N, feature sequence F, and waveform W) in accordance with an instruction (Qn, Qf, or Qw) provided by the user. The editing processor 30 includes a first editor 31, a first generator 32, a second editor 33, a second generator 34, and a third editor 35.

The first editor 31 edits note sequence data Dn. The note sequence data Dn is time-series data representative of a note sequence N of a synthesis sound. Specifically, the first editor 31 edits the note sequence data Dn in accordance with an edit instruction Qn from the user relative to the editing area En. The display controller 20 displays in the editing area En the note sequence N represented by the note sequence data Dn edited by the first editor 31. The note sequence data Dn is an example of “first time-series data.” The edit instruction Qn is an example of a “first instruction.”

The first generator 32 generates feature sequence data Df based on the note sequence data Dn edited by the first editor 31. The feature sequence data Df is time-series data representative of a feature sequence F of the synthesis sound. Of the features constituting the feature sequence F, a feature at a point on the time axis is generated by using, in addition to the data of a note at that point, data of at least one of the previous note or the following note. Thus, the feature sequence data Df is generated in context of a note sequence N represented by the note sequence data Dn.

Specifically, the first generator 32 generates the feature sequence data Df using a first generative model M1. The first generative model M1 is a statistical estimation model that receives the note sequence data Dn as an input and outputs the feature sequence data Df. Specifically, the first generative model M1 is a trained model that has learned a relationship between the note sequence N and the feature sequence F. The first generative model M1 may be a deep neural network (DNN), and may be a deep neural network with any architecture, such as a convolutional neural network (CNN) or a recursive neural network (RNN). An additional element, such as a long short-term memory (LSTM) or self-attention may be included in the first generative model M1.

The first generative model M1 is realized by a combination of a program that causes the controller 11 to execute an operation for generating the feature sequence data Df from the note sequence data Dn, and a set of variables (specifically, weighted values and biases) that are applied to the operation. The set of variables that defines the first generative model M1 is determined in advance by machine learning using a first training data set and is stored in the storage device 12. The first training data set includes pairs of note sequence data Dn and corresponding feature sequence data Df (ground truth). In the machine learning of the first generative model M1, the set of variables of the first generative model M1 is repeatedly updated such that an error is reduced between (i) feature sequence data Dn output by the tentative first generative model M1 based on an input of the note sequence data Dn of the respective pair of the first training data set and (ii) the corresponding feature sequence data Df of the same pair. Consequently, the first generative model M1 outputs feature sequence data Df statistically proper relative to unknown note sequence data Dn under a latent tendency between the note sequence N and the feature sequence F in the first training data set.

The second editor 33 edits the feature sequence data Df generated by the first generator 32. Specifically, the second editor 33 edits the feature sequence data Df in accordance with an edit instruction Qf provided by the user relative to the editing area Ef. The display controller 20 displays in the editing area Ef a feature sequence F represented by the feature sequence data Df generated by the first generator 32, or a feature sequence F represented by the feature sequence data Df edited by the second editor 33. The feature sequence data Df is an example of “second time-series data.” The edit instruction Qf is an example of a “second instruction.”

The second generator 34 generates waveform data Dw from the note sequence data Dn and the feature sequence data Df. The waveform data Dw is time-series data representative of the waveform W of the synthesis sound. In other words, the waveform data Dw is constituted of a time series of samples representative of an audio signal Z. The audio signal Z is generated by D/A conversion and amplification of the waveform data Dw. The waveform data Dw is an example of “third time-series data.” The feature sequence data Df generated and output by the first generator 32 (i.e., feature sequence data Df that is not edited by the second editor 33) may be used for generation of the waveform data Dw.

The second generator 34 generates the waveform data Dw using a second generative model M2. The second generative model M2 is a statistical estimation model for outputting waveform data Dw using a pair of note sequence data Dn and feature sequence data Df (hereafter, “input data Din”) as an input. Specifically, the second generative model M2 is a trained model that has learned a relationship between (i) the pair of the note sequence N and the feature sequence F and (ii) the waveform W. The second generative model M2 may be in the form of a deep neural network. For example, the second generative model M2 may be a deep neural network with any architecture, such as a convolutional neural network or a recursive neural network. An additional element, such as a long and short-term memory or self-attention may be included in the second generative model M2.

The second generative model M2 is realized by a combination of a program that causes the controller 11 to execute an operation to generate the waveform data Dw from the input data Din including note sequence data Dn and feature sequence data Df, and a set of variables (specifically, weighted values and biases) applied to the operation. The set of variables that defines the second generative model M2 is determined in advance by machine learning using a second training data set and is stored in the storage device 12. The second training data set includes pairs of input data Din and the corresponding waveform data Dw. In the machine learning of the second generative model M2, the set of variables of the second generative model M2 is repeatedly updated such that an error is reduced between (i) waveform data Dw output by the tentative second generative model M2 based on the input data Din in the respective pair of the second training data set and (ii) the corresponding waveform data Dw of the same pair. Consequently, the second generative model M2 outputs waveform data Dw statistically proper for unknown input data Din under a latent tendency between (i) a pair of the note sequence N and the feature sequence F and (ii) the waveform W in the second training data set.

The third editor 35 edits the waveform data Dw generated by the second generator 34. Specifically, the third editor 35 edits the waveform data Dw in accordance with an edit instruction Qw provided by the user relative to the editing area Ew. The display controller 20 displays, in the editing area Ew, a waveform W represented by the waveform data Dw generated by the second generator 34 or a waveform W represented by the waveform data Dw edited by the third editor 35. In addition, when the icon B1 (PLAY) is operated by the user, an audio signal Z corresponding to the waveform data Dw generated by the second generator 34 or the waveform data Dw edited by the third editor 35 is supplied to the sound emitting device 13, whereby the synthesis sound is produced.

The information manager 40 controls the version of each of the note sequence data Dn, the feature sequence data Df, and the waveform data Dw. More specifically, the information manager 40 controls the note sequence version number Vn, the feature sequence version number Vf, and the waveform version number Vw.

Further, the information manager 40 saves in the storage device 12 different versions of data (hereafter, “history data”) for each of the note sequence data Dn, the feature sequence data Df, and the waveform data Dw. The storage device 12 has a history area and a work area. The history area is a storage area in which the editing history of the conditions of the synthesis sound is stored. The work area is a storage area in which the note sequence data Dn, the feature sequence data Df, and the waveform data Dw are temporarily saved during the editing process when using the editing screen G.

Specifically, each time the note sequence N is edited in accordance with the edit instruction Qn, the information manager 40 saves in the history area the edited note sequence data Dn as first history data Hn [Vn,Vf,Vw]. That is, the note sequence data Dn of the new version is saved as the first history data Hn [Vn,Vf,Vw] in the storage device 12.

Further, the information manager 40 saves in the history area second history data Hf [Vn,Vf,Vw] that corresponds to the feature sequence data Df edited in accordance with the edit instruction Qf, as a new version. The second history data Hf [Vn,Vf,Vw] of the first embodiment represents how the feature sequence data Df is edited in accordance with edit instructions Qf (i.e., a series of edit instructions Qf). In other words, the second history data Hf [Vn,Vf,Vw]indicates a difference between the feature sequence data Df before editing and the feature sequence data Df after editing. In some embodiments, the second history data Hf [Vn,Vf,Vw] may indicate the entire second time-series data after being edited.

Similarly, the information manager 40 saves in the history area third history data Hw [Vn,Vf,Vw] corresponding to the waveform data Dw edited in accordance with the edit instruction Qw, as a new version. The third history data Hw [Vn,Vf,Vw] of the first embodiment indicates how the waveform data Dw is edited in accordance with edit instructions Qw (i.e., a series of edit instructions Qw). In other words, the third history data Hw [Vn,Vf,Vw] indicates a difference between the waveform data Dw before editing and after editing. In some embodiments, the third history data Hw [Vn,Vf,Vw] may indicate the entire second time-series data after being edited.

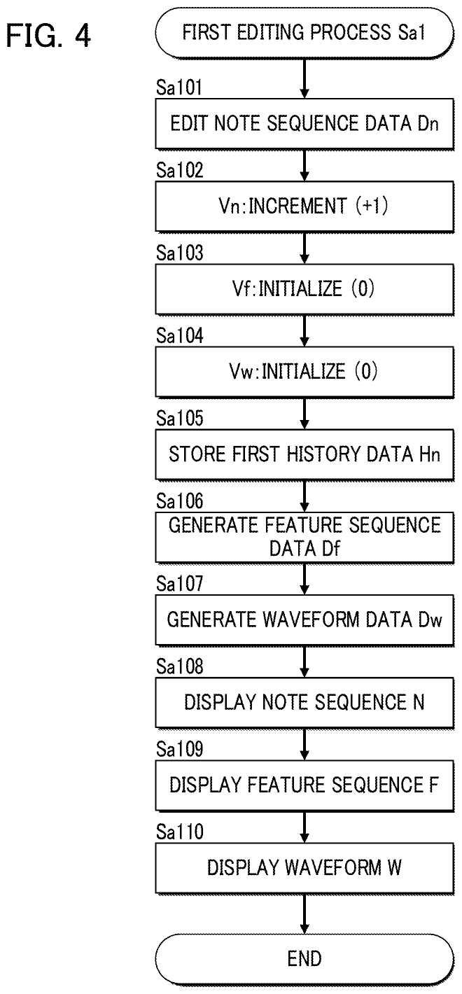

FIGS. 4 to 6 are flowcharts showing example procedures of editing processes Sa (Sa1, Sa2, and Sa3) in which the conditions of a synthesis sound are modified in response to an edit instruction Q (Qn, Qf, or Qw) provided by a user. FIG. 4 is a flowchart of a first editing process Sa1 for editing a note sequence N. The first editing process Sa1 is initiated in response to an edit instruction Qn for editing the note sequence N. When the first editing process Sa1 is started, the first editor 31 modifies the current note sequence data Dn in accordance with the edit instruction Qn (Sa101).

The information manager 40 increments the note sequence version number Vn by “1” (Sa102). In a case in which the edit instruction Qn is provided for the first time, new note sequence data Dn is generated (Sa101), and the note sequence version number Vn is initialized to “0” (Sa102). Further, the information manager 40 initializes the feature sequence version number Vf to “0” (Sa103) and initializes the waveform version number Vw to “0” (Sa104). Then, the information manager 40 saves the note sequence data Dn edited by the first editor 31 in the history area of the storage device 12 as first history data Hn [Vn,Vf=0,Vw=0] of the note sequence N (Sa105).

As will be apparent from the above explanation, each time the note sequence data Dn is edited in accordance with the edit instruction Qn, the note sequence data Dn of the edited version is saved in the history area as the first history data Hn [Vn,Vf=0,Vw=0] (Sa105), the note sequence version number Vn is incremented (Sa102), and the feature sequence version number Vf and the waveform version number Vw are initialized (Sa103 and Sa104).

The first generator 32 generates feature sequence data Df by supplying the note sequence data Dn edited by the first editor 31 to the first generative model M1 (Sa106). The feature sequence data Df generated by the first generator 32 is saved in the work area of the storage device 12. Further, the second generator 34 generates waveform data Dw by supplying input data Din including the note sequence data Dn edited by the first editor 31 and the feature sequence data Df generated by the first generator 32, to the second generative model M2 (Sa107). The waveform data Dw generated by the second generator 34 is saved in the work area of the storage device 12.

The note sequence data Dn contains data for each note. The feature sequence data Df is constituted of samples taken per several milliseconds to several tens of milliseconds to represent variations in pitch within a note. The waveform data Dw represents the waveform of a note, and the waveform data Dw consists of samples at a sample rate of 1/50 kHz to 20 μsec, for example. The data amount of the feature sequence data Df generated from single note sequence data Dn is several hundred to several thousand times the data amount of the note sequence data Dn, and the data amount of the waveform data Dw generated from single feature sequence data Df is several hundred to several thousand times the data amount of the feature sequence data Df. In view of the above-described circumstances, in the first embodiment, the entire data of the higher layer (note sequence data Dn) is saved as the first history data Hn [Vn,Vf=0,Vw=0]. On the other hand, since the data amount of the lower layer data (the feature sequence data Df and the waveform data Dw) is larger, as described above, only the difference between the lower layer data after editing, and the lower layer data generated based on the higher layer data (i.e., the data of the lower layer before editing), is saved as the history data for the lower layer data. According to this configuration, compared with a configuration in which the entire data of the lower layer is saved, it is possible to significantly reduce an amount of data stored in the storage device 12.

The display controller 20 updates the editing screen G (Sa108-Sa110). Specifically, the display controller 20 displays the note sequence N represented by the note sequence data Dn edited by the first editor 31 in the editing area En (Sa108). Further, the display controller 20 displays in the editing area Ef a feature sequence F represented by the current feature sequence data Df saved in the work area (Sa109). Similarly, the display controller 20 displays in the editing area Ew a waveform W represented by the current waveform data Dw saved in the work area (Sa110).

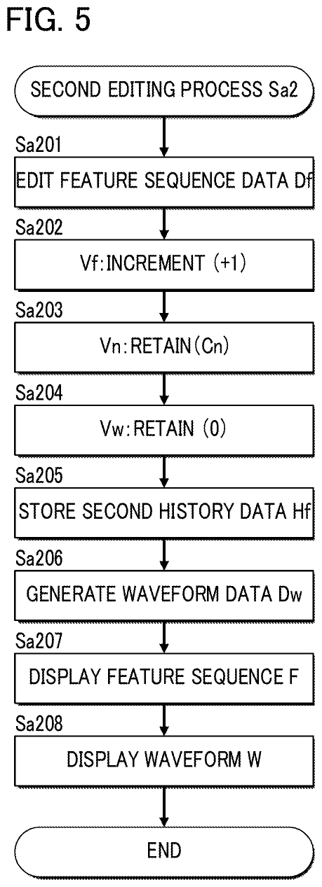

FIG. 5 is a flowchart of a second editing process Sa2 for editing the feature sequence F. The second editing process Sa2 is initiated in response to an edit instruction Qf for editing the feature sequence F. When the second editing process Sa2 is started, the second editor 33 modifies the current feature sequence data Df in accordance with the edit instruction Qf (Sa201).

The information manager 40 increments the feature sequence version number Vf by “1” (Sa202). In addition, the information manager 40 retains the note sequence version number Vn as the current value Cn (Sa203) and initializes the waveform version number Vw to “0” (Sa204). Then, the information manager 40 saves in the history area second history data Hf [Vn,Vf,Vw=0] that represents the current editing instruction Qf as a new version (Sa205).

As will be apparent from the above description, each time the feature sequence data Df is edited in accordance with the edit instruction Qf, the second history data Hf [Vn,Vf,Vw=0] based on the edited feature sequence data Df is saved in the history area (Sa205). The feature sequence version number Vf is incremented (Sa202) while the note sequence version number Vn is retained (Sa203). In addition, the waveform version number Vw is initialized (Sa204). Step Sa203 may be omitted.

The second generator 34 generates waveform data Dw by supplying input data Din including the current note sequence data Dn and the feature sequence data Df edited by the second editor 33, to the second generative model M2 (Sa206). The waveform data Dw generated by the second generator 34 is saved in the work area of the storage device 12.

The display controller 20 updates the editing screen G (Sa207 and Sa208). Specifically, the display controller 20 displays in the editing area Ef the feature sequence F represented by the feature sequence data Df edited by the second editor 33 (Sa207). Further, the display controller 20 displays in the editing area Ew the waveform W represented by the current waveform data Dw saved in the work area (Sa208). In the second editing process Sa2, the note sequence N in the editing area En is not updated.

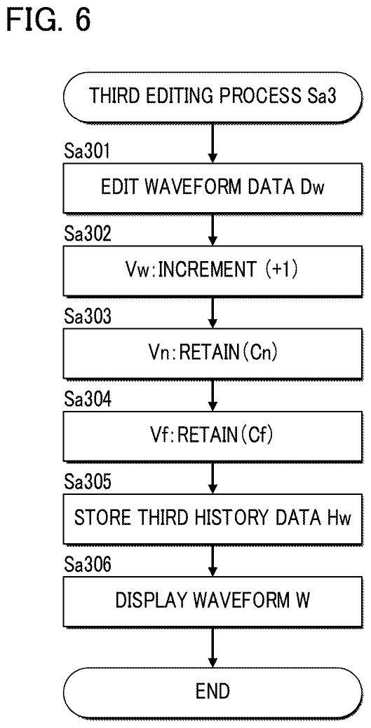

FIG. 6 is a flowchart of a third editing process Sa3 for editing the waveform W. The third editing process Sa3 is initiated in response to an edit instruction Qw to edit the waveform W. When the third editing process Sa3 is started, the third editor 35 edits the current waveform data Dw in accordance with the edit instruction Qw (Sa301).

The information manager 40 increments the waveform version number Vw by “1” (Sa302). In addition, the information manager 40 retains the note sequence version number Vn as the current value Cn (Sa303). The information manager 40 also retains the feature sequence version number Vf as the current value Cf (Sa304). Then, the information manager 40 saves in the history area third history data Hw [Vn,Vf,Vw] that represents the current edit instruction Qw as a new version (Sa305).

As will be apparent from the above description, each time the waveform data Dw is edited in accordance with the edit instruction Qw, the third history data Hw [Vn,Vf,Vw] based on the edited waveform data Dw is saved in the history area (Sa305), and the waveform version number Vw is incremented (Sa302). On the other hand, the note sequence version number Vn and the feature sequence version number Vf are retained (Sa303 and Sa304). Steps Sa303 and Sa304 may be omitted.

The display controller 20 displays in the editing area Ew a waveform W represented by the waveform data Dw edited by the third editor 35 (Sa306). In the third editing process Sa3, the note sequence N in the editing area En is not updated. The feature sequence F in the editing area Ef is also not updated.

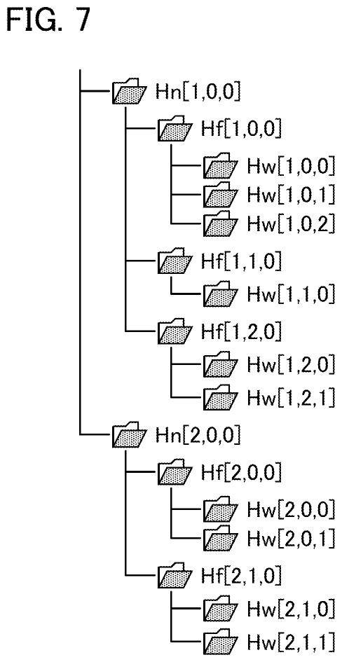

FIG. 7 is an explanatory diagram of a data structure in the history area of the storage device 12. The history area stores a plurality of first history data Hn [Vn,Vf=0,Vw=0] (note sequence data Dn) corresponding to the note sequences N of different versions. For each of the plurality of first history data Hn [Vn,Vf=0,Vw=0], a plurality of second history data Hf [Vn,Vf,Vw=0] corresponding to the feature sequences F of different versions with the common note sequence N is stored in the history area. Further, for each of the plurality of second history data Hf [Vn,Vf,Vw=0], a plurality of third history data Hw [Vn,Vf,Vw] corresponding to the waveforms W of different versions with the common feature sequence F is stored in the history area. As discussed above, a hierarchical relationship stands in which the note sequence N is located above the feature sequence F and in which the feature sequence F is located above the waveform W. In response to an edit of the feature sequence F, the feature sequence version number Vf is incremented. In addition, the waveform version number Vw corresponding to the lower layer is initialized to “0” while the note sequence version number Vn corresponding to the upper layer is retained.

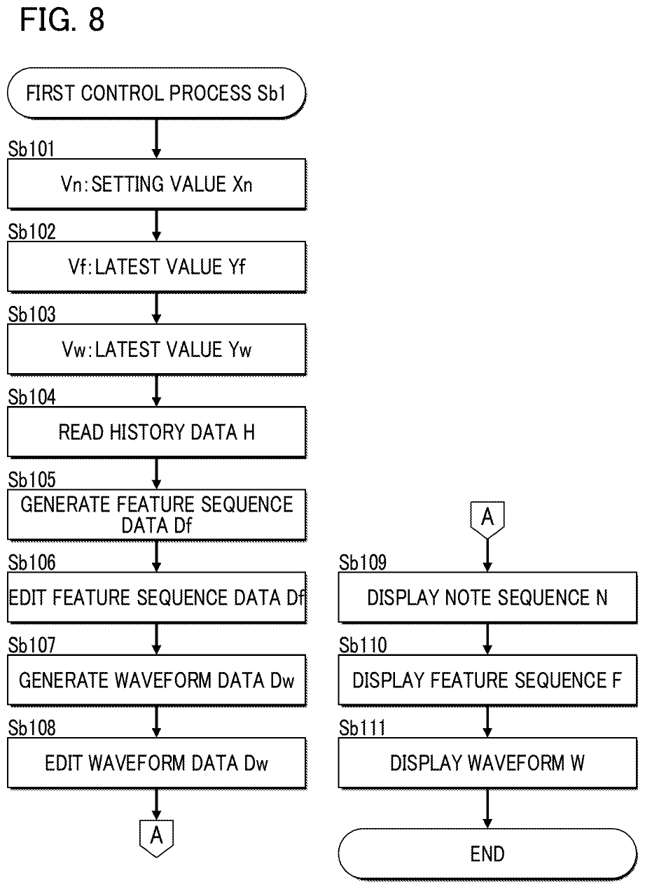

FIGS. 8 to 10 are flowcharts showing example procedures of version control processes Sb (Sb1, Sb2, and Sb3) for controlling versions in response to a user instruction. FIG. 8 is a flowchart of a first control process Sb1 for controlling the version of the note sequence N. In response to an instruction provided by the user to change the note sequence version number Vn, the first control process Sb1 is initiated.

The value of the note sequence version number Vn changed in accordance with the instruction provided by the user will be hereinafter referred to as a “setting value Xn.” In a case in which the user directly changes the note sequence version number Vn in the area Gn, the setting value Xn will be the value changed by the user (i.e., the value designated by the user). In a case in which the user operates the icon Gn1, the setting value Xn will be a value (=Cn−1) immediately before the current value Cn of the note sequence version number Vn. On the other hand, in a case in which the user operates the icon Gn2, the setting value Xn will be a value (=Cn+1) immediately after the current value Cn of the note sequence version number Vn. The setting value Xn is an example of a “first setting value.”

When the first control process Sb1 is started, the information manager 40 changes the note sequence version number Vn from the current value Cn to the setting value Xn (Sb101).

The information manager 40 sets the feature sequence version number Vf to the latest value Yf corresponding to the setting value Xn of the note sequence N (Sb102). The latest value Yf is the version number of the latest version among plural versions of the feature sequence F, each being generated for the corresponding edit instruction Qf under a version indicated by the setting value Xn.

The information manager 40 sets the waveform version number Vw to the latest value Yw corresponding to the setting value Xn of the note sequence N (Sb103). The latest value Yw is the version number of the latest version among plural versions of the waveform W, each being generated for the corresponding edit instruction Qw under versions indicated by the setting value Xn and the latest value Yf.

The information manager 40 acquires the first history data Hn [Vn=Xn,Vf=0,Vw] of the note sequence N=0, the second history data Hf [Vn=Xn,Vf=1,Vw=0] to Hf [Vn=Xn,Vf=Yf,Vw=0] of the feature sequence F, and the third history data Hw [Vn=Xn,Vf=Yf, Vw=1] to Hw [Vn=Xn,Vf=Yf,Vw=Yw] of the waveform W from the history area of the storage device 12 (Sb104). The second history data Hf [Vn=Xn,Vf=1,Vw=0] to Hf [Vn=Xn,Vf=Yf,Vw=0] is acquired in a case in which the feature F is edited, and is not acquired in a case in which the feature F is not edited. The first history data Hn [Vn=Xn,Vf=0,Vw=0] of the note sequence N is the note sequence data Dn representative of the note sequence N for which the note sequence version number Vn is the setting value Xn. The second history data Hf [Vn=Xn,Vf=1,Vw=0] to Hf [Vn=Xn,Vf=Yf,Vw=0] of the feature sequence F represents a series of edit instructions Qf including the Yf-th and earlier edit instructions, among one or more edit instructions Qf sequentially input by the user, under the version indicated by the note sequence version number Vn of the setting value Xn. The third history data Hw [Vn=Xn,Vf=Yf,Vw=1] to Hw [Vn=Xn,Vf=Yf,Vw=Yw] of the waveform W represents a series of edit instructions Qw including the Yw-th and earlier edit instructions, among one or more edit instructions Qw sequentially input by the user, under the versions indicated by the note sequence version number Vn of the setting value Xn and the feature sequence version number Vf of the latest value Yf.

The first generator 32 generates feature sequence data Df by supplying the first history data Hn [Vn=Xn,Vf=0,Vw=0] (note sequence data Dn) acquired by the information manager 40 to the first generative model M1 (Sb105). The second editor 33 sequentially edits the feature sequence data Df in accordance with one or more edit instructions Qf indicated by one or more second history data Hf [Vn=Xn,Vf=1,Vw=0] to Hf [Vn=Xn,Vf=Yf,Vw=0] acquired by the information manager 40 (Sb106). That is, the feature sequence data Df edited in accordance with the one or more edit instructions Qf up to the Yf-th instruction is generated, under the note sequence N corresponding to the setting value Xn. The second editor 33 edits only a small part of the feature sequence data Df corresponding to a plurality of notes. For example, only a minimal portion of the entire song is edited, such as an attack portion of a particular note in a piece of music or the first two notes in a third phrase in the piece of music.

The second generator 34 generates the waveform data Dw by supplying the input data Din including the first history data Hn [Vn=Xn,Vf=0,Vw=0](note sequence data Dn) acquired by the information manager 40 and the edited feature sequence data Df, to the second generative model M2 (Sb107). The third editor 35 sequentially edits the waveform data Dw in accordance with one or more edit instructions Qw indicated by one or more third history data Hw [Vn=Xn,Vf=Yf,Vw=1] to Hw [Vn=Xn,Vf=Yf,Vw=Yw] acquired by the information manager 40 (Sb108). Thus, the waveform data Dw edited in accordance with the one or more edit instructions Qw up to Yw-th instruction is generated, under the note sequence N corresponding to the setting value Xn and the feature sequence F corresponding to the latest value Yf. In a case in which there is no second history data Hf [Vn=Xn,Vf=1,Vw=0] to Hf [Vn=Xn,Vf=Yf,Vw=0], the third history data Hw [Vn=Xn,Vf=Yf,Vw=1] to Hw [Vn=Xn,Vf=Yf,Vw=Yw] is not acquired. Consequently, the waveform data Dw is not edited at step Sb108, and the waveform data Dw is determined as final data. In a case in which an edit instruction to shift the waveform W along the timeline is provided, only the edit instruction Qw indicating “shifting the section from time t1 to time t2 by X milliseconds,” for example, is saved as the third history data Hw [Vn=Xn,Vf=Yf,Vw=1] to Hw [Vn=Xn,Vf=Yf,Vw=Yw]. Therefore, it is possible to significantly reduce an amount of data stored in the storage device 12 as compared with a configuration in which the sample data of the waveform W of the entire piece of music is saved after the waveform W is shifted. The same applies when a volume of the waveform W or the filter of the waveform W is edited. When the volume of the waveform W is edited, a transition in volume change in the edited section is saved. When the filter of the waveform W is edited, parameters of the filter in the edited section are saved.

The display controller 20 updates the editing screen G (Sb109-Sb111). Specifically, the display controller 20 displays in the editing area En the note sequence N represented by the first history data Hn [Vn=Xn,Vf=0,Vw=0] (note sequence data Dn) acquired by the information manager 40, and updates the note sequence version number Vn displayed in the area Gn to the setting value Xn (Sb109). That is, the note sequence N edited in accordance with the Xn-th edit instruction Qn is displayed in the editing area En.

Further, the display controller 20 displays in the editing area Ef the feature sequence F represented by the feature sequence data Df edited by the second editor 33, and updates the feature sequence version number Vf displayed in the area Gf to the latest value Yf (Sb110). That is, the feature sequence F corresponding to the setting value Xn and the latest value Yf is displayed in the editing area E2. Similarly, the display controller 20 displays in the editing area Ew waveform W represented by the waveform data Dw edited by the third editor 35, and updates the waveform version number Vw displayed in the area Gw to the latest value Yw (Sb111). That is, the waveform W corresponding to the setting value Xn, the latest value Yf, and the latest value Yw is displayed in the editing area Ew. In the above described state, the user can provide an edit instruction (Qn, Qf, or Qw) for each of the note sequence N, the feature sequence F, and the waveform W.

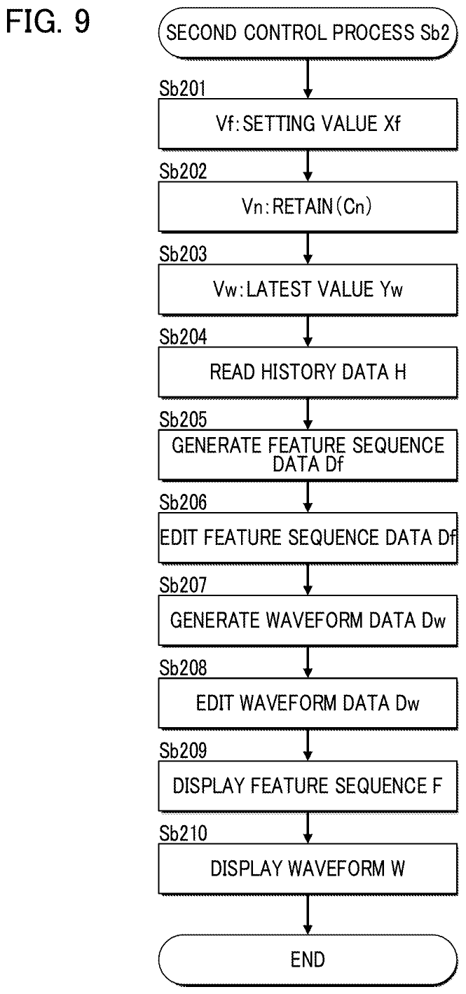

FIG. 9 is a flowchart of a second control process Sb2 for controlling the version of the feature sequence F. In response to an instruction provided by the user to change the feature sequence version number Vf, the second control process Sb2 is initiated.

The value of the feature sequence version number Vf changed in accordance with the instruction provided by the user will be hereinafter referred to as a “setting value Xf.” In a case in which the user directly changes the feature sequence version number Vf in the area Gf, the setting value Xf will be the value changed by the user (i.e., the value designated by the user). In a case in which the user operates the icon Gf1, the setting value Xf will be a value (=Cf−1) immediately before the current value Cf of the feature sequence version number Vf. In a case in which the user operates the icon Gf2, the setting value Xf will be a value (=Cf+1) immediately after the current value Cf of the feature sequence version number Vf. The setting value Xf is an example of a “second setting value.”

When the second control process Sb2 is started, the information manager 40 changes the feature sequence version number Vf from the current value Cf to the setting value Xf (Sb201). In addition, the information manager 40 retains the note sequence version number Vn as the current value Cn (Sb202), and changes the waveform version number Vw from the current value Cw to the latest value Yw (Sb203). The latest value Yw of the waveform version number Vw is the number of the latest version among a plurality of versions of the waveform W generated for respective edit instructions Qw, under versions indicated by the setting value Xf and the current value Cn.

The information manager 40 acquires the first history data Hn [Vn=Cn,Vf=0,Vw=0] of the note sequence N, the second history data Hf [Vn=Cn,Vf=1,Vw=0] to Hf [Vn=Cn,Vf=Xf,Vw=0] of the feature sequence F, and the third history data Hw [Vn=Cn,Vf=Xf,Vw=1] to Hw [Vn=Xn,Vf=Xf,Vw=Yw] of the waveform W from the history area of the storage device 12 (Sb204). The first history data Hn [Vn=Cn,Vf=0,Vw=0] of the note sequence N is note sequence data Dn representing the note sequence N of the current version. The second history data Hf [Vn=Cn,Vf=1,Vw=0] to Hf [Vn=Cn,Vf=Xf,Vw=0] of the feature sequence F represents a series of edit instructions Qf including the Xf-th and earlier edit instructions, among one or more edit instructions Qf sequentially provided by the user, under a version indicated by the current value Cn. The third history data Hw [Vn=Cn,Vf=Xf,Vw=1] to Hw [Vn=Xn,Vf=Xf,Vw=Yw] of the waveform W represents a series of edit instructions Qw including the Yw-th and earlier edit instructions, among one or more edit instructions Qw sequentially provided by the versions indicated by the note sequence version number Vn of the current value Cn and the feature sequence version number Vf of the setting value Xf.

The first generator 32 generates feature sequence data Df by supplying to the first generative model M1 the first history data Hn [Vn=Cn,Vf=0,Vw=0](note sequence data Dn) acquired by the information manager 40 (Sb205). The second editor 33 sequentially edits the feature sequence data Df in accordance with one or more edit instructions Qf indicated by one or more second history data Hf [Vn=Cn,Vf=1,Vw=0] to Hf [Vn=Cn,Vf=Xf,Vw=0] acquired by the information manager 40 (Sb206). Thus, the feature sequence data Df edited in accordance with the one or more edit instructions Qf up to the Xf-th is generated, with the note sequence N corresponding to the current value Cn.

The second generator 34 generates waveform data Dw by supplying to the second generative model M2 input data Din including the first history data Hn [Vn=Cn,Vf=0,Vw=0] (note sequence data Dn) acquired by the information manager 40 and the edited feature sequence data Df (Sb207). The third editor 35 sequentially edits the waveform data Dw in accordance with one or more edit instructions Qw indicated by one or more third history data Hw [Vn=Cn,Vf=Xf,Vw=1] to Hw [Vn=Xn,Vf=Xf,Vw=Yw] acquired by the information manager 40 (Sb208). That is, the waveform data Dw edited in accordance with the one or more edit instructions Qw up to the Yw-th is generated, with the note sequence N corresponding to the current value Cn and the feature sequence F corresponding to the setting value Xf.

The display controller 20 updates the editing screen G (Sb209-Sb210). Specifically, the display controller 20 displays in the editing area Ef a feature sequence F represented by the feature sequence data Df edited by the second editor 33, and updates the feature sequence version number Vf displayed in the area Gf to the setting value Xf (Sb209). That is, the feature sequence F corresponding to the current value Cn and the setting value Xf is displayed in the editing area Ef. Further, the display controller 20 displays in the editing area Ew waveform W represented by the waveform data Dw edited by the third editor 35, and updates the waveform version number Vw displayed in the area Gw to the latest value Yw (Sb210). Thus, the waveform W corresponding to the current value Cn, the setting value Xf, and the latest value Yw is displayed in the editing area Ew. In the above described state, the user can provide an edit instruction (Qn, Qf, or Qw) for each of the note sequence N, the feature sequence F, and the waveform W.

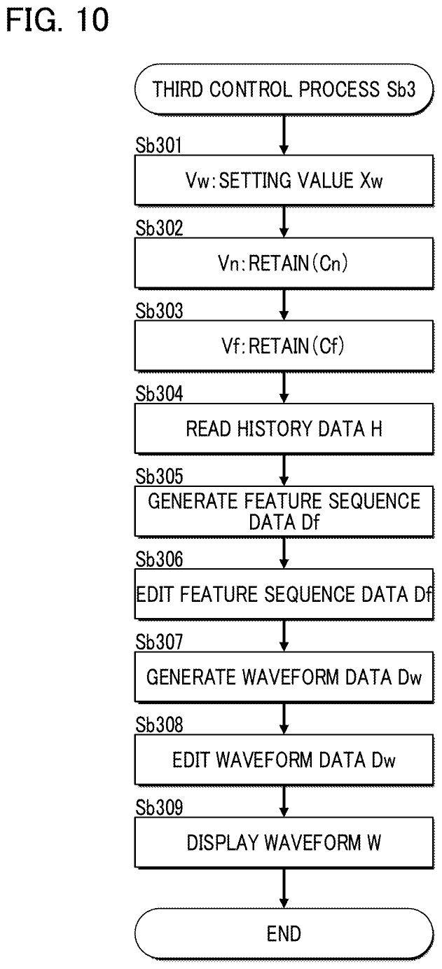

FIG. 10 is a flowchart of a third control process Sb3 for controlling the version of the waveform W. In response to an instruction provided by the user to change the waveform version number Vw, the third control process Sb3 is initiated.

The value of the waveform version number Vw changed in accordance with the instruction provided by the user will be hereinafter referred to as a “setting value Xw.” In a case in which the user directly changes the waveform version number Vw in the area Gw, the setting value Xw will be the value changed by the user (i.e., the value designated by the user). In a case in which the user operates the icon Gw1, the setting value Xw will be a value (=Cw−1) immediately before the current value Cw of the waveform version number Vw. In a case in which the user operates the icon Gw2, the setting value Xw will be a value (=Cw+1) immediately after the current value Cw of the waveform version number Vw.

When the third control process Sb3 is started, the information manager 40 changes the waveform version number Vw from the current value Cw to the setting value Xw (Sb301). The information manager 40 retains the note sequence version number Vn as the current value Cn (Sb302), and retains the feature sequence version number Vf as the current value Cf (Sb303).

The information manager 40 acquires the first history data Hn [Vn=Cn,Vf=0,Vw=0] of the note sequence N, the second history data Hf [Vn=Cn,Vf=1,Vw=0] to Hf [Vn=Cn,Vf=Cf,Vw=0] of the feature sequence F, and the third history data Hw [Vn=Cn,Vf=Cf,Vw=1] to Hw [Vn=Cn,Vf=Cf,Vw=Xw] of the waveform W from the history area of the storage device 12 (Sb304). The first history data Hn [Vn=Cn,Vf=0,Vw=0] of the note sequence N is note sequence data Dn that represents the note sequence N of the current version. The second history data Hf [Vn=Cn,Vf=1,Vw=0] to Hf [Vn=Cn,Vf=Cf,Vw=0] of the feature sequence F represents a series of edit instructions Qf including the Cf-th and earlier edit instructions, among one or more edit instructions Qf sequentially provided by the user, under the note sequence N of the note sequence version number Vn being the setting value Xn.

The third history data Hw [Vn=Cn,Vf=Cf,Vw=1] to Hw [Vn=Cn,Vf=Cf,Vw=Xw] of the waveform W represents a series of the edit instructions Qw including the Xw-th and earlier edit instructions, among one or more edit instructions Qw sequentially provided by the user, under the note sequence N of the current version and the feature sequence F of the current version.

The first generator 32 generates feature sequence data Df by supplying to the first generative model M1 the first history data Hn [Vn=Cn,Vf=0,Vw=0](note sequence data Dn) acquired by the information manager 40 (Sb305). The second editor 33 sequentially edits the feature sequence data Df in accordance with one or more edit instructions Qf indicated by one or more second history data Hf [Vn=Cn,Vf=1,Vw=0] to Hf [Vn=Cn,Vf=Cf,Vw=0] acquired by the information manager 40 (Sb306). Thus, the feature sequence data Df edited in accordance with the one or more edit instructions Qf up to the Cf-th is generated, under the note sequence N corresponding to the current value Cn.

The second generator 34 generates waveform data Dw by supplying to the second generative model M2 input data Din including (i) the first history data Hn [Vn=Cn,Vf=0,Vw=0] (note sequence data Dn) acquired by the information manager 40 and (ii) the edited feature sequence data Df (Sb307). The third editor 35 sequentially edits the waveform data Dw in accordance with one or more edit instructions Qw indicated by one or more third history data Hw [Vn=Cn,Vf=Cf,Vw=1] to Hw [Vn=Cn,Vf=Cf,Vw=Xw] acquired by the information manager 40 (Sb308). Thus, the waveform data Dw edited in accordance with the one or more edit instructions Qw up to the Xw-th are generated under the note sequence N corresponding to the current value Cn and the feature sequence F corresponding to the current value Cf.

The display controller 20 updates the editing screen G (Sb309). Specifically, the display controller 20 displays in the editing area Ew a waveform W represented by the waveform data Dw edited by the third editor 35, and updates the waveform version number Vw displayed in the area Gw to the setting value Xw. That is, the waveform W corresponding to the current value Cn, the current value Cf, and the setting value Xf is displayed in the editing area Ew.

As described above, in the first embodiment, the note sequence data Dn and the feature sequence data Df are edited in accordance with instructions (an edit instruction Qn and an edit instruction Qf) provided by the user. Therefore, it is possible to generate waveform data Dw that precisely reflects instructions provided by the user as compared with a configuration in which only the note sequence data Dn is edited in accordance with instructions provided by the user.

Moreover, in response to editing of the note sequence data Dn, the note sequence version number Vn is incremented, and the feature sequence version number Vf is initialized. In response to editing of the feature sequence data Df, the feature sequence version number Vf is incremented while the note sequence version number Vn is retained. The waveform data Dw is then generated using at least one of (i) the first history data Hn [Vn,Vf,Vw] corresponding to the setting value Xn changed in accordance with the instruction provided by the user, among the values of the note sequence version number Vn, or (ii) the second history data Hf [Vn,Vf,Vw] corresponding to the setting value Xf changed in accordance with the instruction provided by the user, among the values of the feature sequence version number Vf. Accordingly, the user can provide instructions to edit the note sequence data Dn and the feature sequence data Df while generating the waveform data Dw using trial and error on various combinations of the note sequence version number Vn and the feature sequence version number Vf.

### B: Second Embodiment

A second embodiment will now be described. Elements in each mode exemplified below that have functions similar to those of the elements in the first embodiment will be denoted by reference signs similar to those in the first embodiment and detailed description of such elements will be omitted, as appropriate.

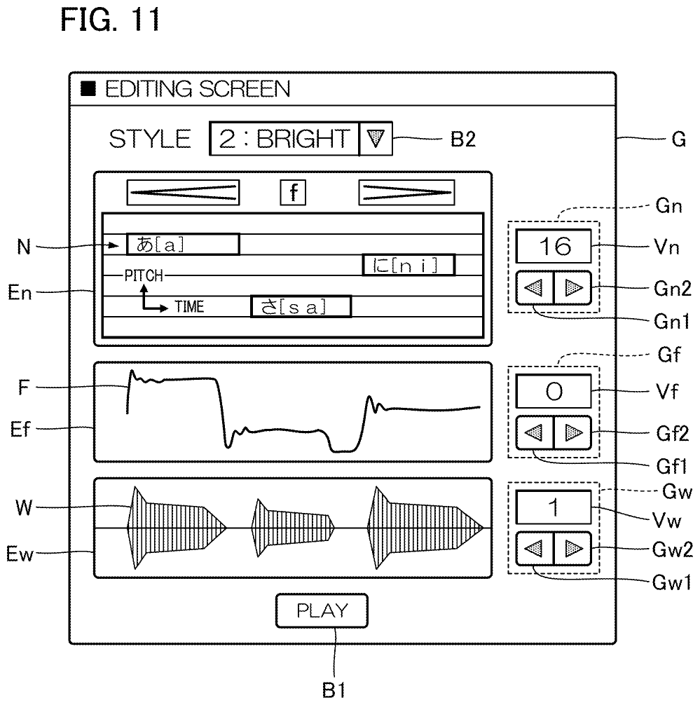

FIG. 11 is a schematic diagram of an editing screen G according to the second embodiment. The icon B2 is displayed in the editing screen G of the second embodiment, in addition to the same elements as those of the first embodiment. The icon B2 is an image (specifically, a pull-down menu) for use by the user to select a sounding style of the synthesis sound. The user can select a desired sounding style from among a plurality of sounding styles by operating the operation device 15.

A sounding style refers to a characteristic of how a sound is produced. For example, when the synthesis sound is an instrumental sound, the sounding style is a characteristic of a playing style of a musical instrument. For example, when the synthesis sound is a singing sound, the sounding style is a characteristic of a singing style. Specifically, a sounding style appropriate for different musical genres, such as pop, rock, and rap, is an example of the sounding style. Also, a musical expression in instrumental playing or singing, such as bright, calm, and dramatic, is an example of the sounding style.

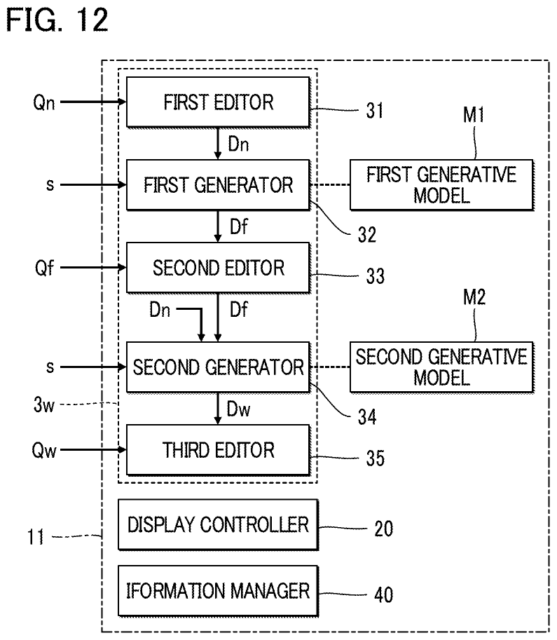

FIG. 12 is a block diagram showing a functional configuration of the controller 11 according to the second embodiment. A sounding style “s” selected by the user by operating the icon B2 is indicated to the first generator 32 and the second generator 34 in the second embodiment.

The first generator 32 generates feature sequence data Df from the note sequence data Dn and the sounding style s. The feature sequence data Df is time-series data representative of a series of features (e.g., a series of fundamental frequencies) of a synthesis sound, which is a sound representation of the note sequence N represented by the note sequence data Dn sounded according to the sounding style s.

Specifically, the first generator 32 generates the feature sequence data Df using the first generative model M1. The first generative model M1 is a statistical estimation model that receives the note sequence data Dn and the sounding style s as inputs, and outputs the feature sequence data Df. Similar to the first embodiment, the first generative model M1 may be a deep neural network with any architecture, such as a convolutional neural network or a recursive neural network. Specifically, the first generative model M1 is realized by a combination of a program that causes the controller 11 to execute an operation to generate the feature sequence data Df from the note sequence data Dn and the sounding style s, and a set of variables applied to the operation.

The set of variables defining the first generative model M1 is determined in advance by machine learning using a first training data set and stored in the storage device 12. The first training data set includes pairs of (i) a set of the note sequence data Dn and the sounding style s and (ii) the corresponding feature sequence data Df (ground truth). In the machine learning of the first generative model M1, a set of variables of the first generative model M1 is repeatedly updated such that an error is reduced between (i) feature sequence data Df output by the tentative first generative model M1 based on the note sequence data Dn and the sounding style s of the respective pair of the first training data set and (ii) the corresponding feature sequence data Df of the same pair. Therefore, the first generative model M1 outputs the feature sequence data Df that is statistically proper for an unknown combination of note sequence data Dn and a sounding style s under a tendency latent in the first training data set.

The second generator 34 generates waveform data Dw from the note sequence data Dn, the feature sequence data Df, and the sounding style s. The waveform data Dw is time-series data representative of a waveform of a synthesis sound in which the note sequence N represented by the note sequence data Dn is sounded in the sounding style s.

Specifically, the second generator 34 generates the waveform data Dw using the second generative model M2. The second generative model M2 is a statistical estimation model that receives the note sequence data Dn, the feature sequence data Df, and the sounding style s as inputs, and outputs the waveform data Dw. Similar to the first embodiment, the second generative model M2 may be a deep neural network with any architecture, such as a convolutional neural network or a recursive neural network. Specifically, the second generative model M2 is realized by a combination of a program that causes the controller 11 to execute an operation to generate the waveform data Dw from the note sequence data Dn, the feature sequence data Df, and the sounding style s, and a set of variables applied to the operation.

The set of variables that defines the second generative model M2 is determined in advance by machine learning using a second training data set and is stored in the storage device 12. The second training data set includes pairs of (i) a set of the note sequence data Dn, the feature sequence data Df, and the sounding style s, and (ii) the corresponding waveform data Dw (ground truth). In the machine learning of the second generative model M2, the set of variables of the second generative model M2 is repeatedly updated such that an error is reduced between (i) waveform data Dw output by the tentative second generative model M2 based on the note sequence data Dn, the feature sequence data Df, and the sounding style s of the respective pair of the second training data set and (ii) the corresponding waveform data Dw of the same pair. Accordingly, the second generative model M2 outputs a statistically proper waveform data Dw for an unknown combination of note sequence data Dn, feature sequence data Df, and a sounding style s under a tendency latent in the second training data set.

At step Sa201 of the second editing process Sa2, the first editor 31 edits feature sequence data Df that represent a feature sequence F of a synthesis sound in which a note sequence N is sounded in a sounding style s selected by the user, in accordance with the edit instruction Qf provided by the user. At step Sa205 of the second editing process Sa2, for each version of the feature sequence data, the information manager 40 saves in the history area of the storage device 12 the second history data Hf [Vn,Vf,Vw] in accordance with the edited feature sequence data Df.

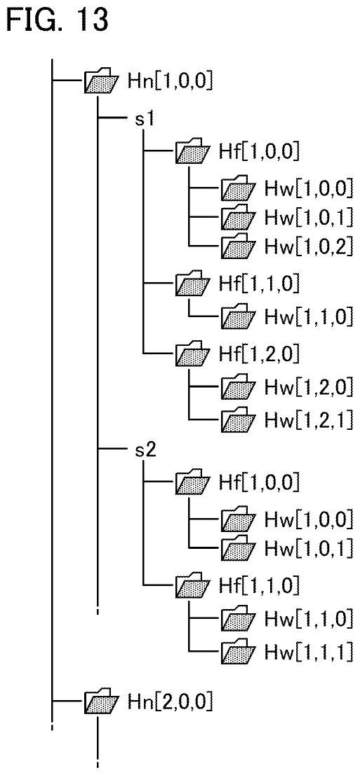

As will be apparent from the above explanation, the feature sequence data Df according to the sounding style s and the waveform data Dw according to the sounding style s are generated, based on a specific note sequence N. The note sequence N is not affected by the sounding style s. Therefore, as shown in FIG. 13, for the first history data Hn [Vn,Vf,Vw] (note sequence data Dn) corresponding to one note sequence N, a plurality of second history data Hf [Vn,Vf,Vw] corresponding to different feature sequences F and a plurality of third history data Hw [Vn,Vf,Vw] corresponding to different waveforms W is saved in the history area of the storage device 12 for each sounding style s.

Next, an example operation of the second embodiment will be described. In the first editing process Sa1, feature sequence data Df is generated by the first generator 32, the generated feature sequence data Df representing a feature sequence F of a synthesis sound produced by sounding the note sequence N in the sounding style s (Sa106). Waveform data Dw representing a waveform W of the synthesis sound is generated by the second generator 34 (Sa107).

In the second editing process Sa2, the second editor 33 edits the generated feature sequence data Df in the sounding style s in accordance with an edit instruction Qf provided by the user. The information manager 40 saves in the history area the second history data Hf [Vn,Vf,Vw] based on the edited feature sequence data Df each time the feature sequence data Df is edited (i.e., for each version of the feature sequence data Df).

Similarly, in the third editing process Sa3, the third editor 35 edits the generated waveform data Dw in the sounding style s in accordance with an edit instruction Qw provided by the user. The information manager 40 saves in the history area the third history data Hw [Vn,Vf,Vw] corresponding to the edited waveform data Dw each time the waveform data Dw is edited (i.e., for each version of the waveform data Dw).

In the second embodiment, with the sounding style s being selected, the first control process Sb1 is initiated in response to an instruction provided by the user to change the note sequence version number Vn. At step Sb104 of the first control process Sb1, the information manager 40 acquires from the history area the first history data Hn [Vn=Xn,Vf=0,Vw=0] of the note sequence N, the second history data Hf [Vn=Xn,Vf=1,Vw=0] to Hf [Vn=Xn,Vf=Yf,Vw=0] of the feature sequence F corresponding to the sounding style s, and the third history data Hw [Vn=Xn,Vf=Yf,Vw=1] to Hw [Vn=Xn,Vf=Yf,Vw=Yw] of the waveform W corresponding to the sounding style s. At steps Sb105 to Sb108 of the first control process Sb1, the feature sequence data Df of the feature sequence F corresponding to the sounding style s and the waveform data Dw of the waveform W corresponding to the sounding style s is generated.

In the second embodiment, with the sounding style s being selected, the second control process Sb2 is initiated in response to an instruction provided by the user to change the feature sequence version number Vf. At step Sb204 of the second control process Sb2, the information manager 40 acquires, from the history area, the first history data Hn [Vn=Cn,Vf=0,Vw=0] of the note sequence N, the second history data Hf [Vn=Cn,Vf=1,Vw=0] to Hf [Vn=Cn,Vf=Xf,Vw=0] of the feature sequence F corresponding to the sounding style s, and the third history data Hw [Vn=Cn,Vf=Xf,Vw=1] to Hw [Vn=Xn,Vf=Xf,Vw=Yw] of the waveform W corresponding to the sounding style s. The “feature sequence F corresponding to the sounding style s” is a feature sequence F corresponding to the note sequence version number Vn (setting value Xn), the sounding style s, and to the feature sequence version number Vf (latest value Yf). The “waveform W corresponding to the sounding style s” is a waveform W corresponding to the note sequence version number Vn (setting value Xn), the sounding style s, the feature sequence version number Vf (latest value Yf), and to the waveform version number Vw (latest value Yw). At steps Sb205 to Sb208 of the second control process Sb2, the feature sequence data Df of the feature sequence F corresponding to the sounding style s and the waveform data Dw of the waveform W corresponding to the sounding style s is generated. The “feature sequence F corresponding to the sounding style s” is a feature sequence F corresponding to the note sequence version number Vn (current value Cn), the sounding style s, and to the feature sequence version number Vf (setting value Xf). The “waveform W corresponding to the sounding style s” is a waveform W corresponding to the note sequence version number Vn (current value Cn), the sounding style s, the feature sequence version number Vf (setting value Xf), and to the waveform version number Vw (latest value Yw).

In the second embodiment, the third control process Sb3 is initiated in response to an instruction provided by the user to change the waveform version number Vw with the sounding style s being selected. At step Sb304 of the third control process Sb3, the information manager 40 acquires, from the history area, the first history data Hn [Vn=Cn,Vf=0,Vw=0] of the note sequence N, the second history data Hf [Vn=Cn,Vf=1,Vw=0] to Hf [Vn=Cn,Vf=Cf,Vw=0] of the feature sequence F corresponding to the sounding style s, and the third history data Hw [Vn=Cn,Vf=Cf,Vw=1] to Hw [Vn=Cn,Vf=Cf,Vw=Xw] of the waveform W corresponding to the sounding style s. At steps Sb305 to Sb308 of the third control process Sb3, the feature sequence data Df of the feature sequence F corresponding to the sounding style s and the waveform data Dw of the waveform W corresponding to the sounding style s is generated. Specifically, the “feature sequence F corresponding to the sounding style s” is a feature sequence F corresponding to the note sequence version number Vn (current value Cn), the sounding style s, and to the feature sequence version number Vf (current value Cf). Specifically, the “waveform W corresponding to the sounding style s” is a waveform W corresponding to the note sequence version number Vn (current value Cn), the sounding style s, the feature sequence version number Vf (current value Cf), and to the waveform version number Vw (setting value Xw).

Attention is now given to a sounding style s1 and a sounding style s2 selectable by the user from among plural sounding styles s. The sounding style s1 and the sounding style s2 differ from each other.

It is first assumed that the sounding style s1 is selected. In the second editing process Sa2, the second editor 33 edits the feature sequence data Df in the sounding style s1 in accordance with an edit instruction Qf provided by the user. Then, each time the feature sequence data Df is edited, the information manager 40 saves in the history area the second history data Hf [Vn,Vf,Vw] based on the edited feature sequence data Df. Similarly, in the third editing process Sa3, the third editor 35 edits the waveform data Dw in the sounding style s1 in accordance with an edit instruction Qw provided by the user. Each time the waveform data Dw is edited, the information manager 40 saves in the history area the third history data Hw [Vn,Vf,Vw] based on the edited waveform data Dw.

Based on the sounding style s1 being selected, the feature sequence data Df of the feature sequence F corresponding to the sounding style s1 and the waveform data Dw of the waveform W corresponding to the sounding style s1 is generated at step Sb104 of the first control process Sb1, at step Sb204 of the second control process Sb2, and at step Sb304 of the third control process Sb3. Thus, there are generated the feature sequence data Df and the waveform data Dw corresponding to the history data H in accordance with edit instructions (Qn, Qf, Qw) provided by the user, from among the history data H (Hn, Hf, Hw) corresponding to the sounding style s1.

It is now assumed that the sounding style s2 is selected. In the second editing process Sa2, the second editor 33 edits the feature sequence data Df in the sounding style s2 in accordance with an edit instruction Qf provided by the user. Then, each time the feature sequence data Df is edited, the information manager 40 saves in the history area the second history data Hf [Vn,Vf,Vw] based on the edited feature sequence data Df. Similarly, in the third editing process Sa3, the third editor 35 edits the waveform data Dw in the sounding style s2 in accordance with an edit instruction Qw provided by the user. Then, each time the waveform data Dw is edited, the information manager 40 stores in the history area the third history data Hw [Vn,Vf,Vw] based on the edited waveform data Dw.

Based on the sounding style s2 being selected, the feature sequence data Df of the feature sequence F corresponding to the sounding style s2 and the waveform data Dw of the waveform W corresponding to the sounding style s2 are generated at step Sb104 of the first control process Sb1, at step Sb204 of the second control process Sb2, and at step Sb304 of the third control process Sb3. Thus, there are generated the feature sequence data Df and the waveform data Dw corresponding to the history data H in accordance with an edit instruction (Qn, Qf, or Qw) provided by the user, from among the history data H (Hn, Hf, and Hw) corresponding to the sounding style s2.

As will be apparent from the above examples, the editing processor 30 in the second embodiment acquires, in accordance with the note sequence data Dn of the same version, the feature sequence data Df and the waveform data Dw corresponding to the sounding style s1, or the feature sequence data Df and the waveform data Dw corresponding to the sounding style s2.

As discussed above, in the second embodiment, the editing history of the feature sequence data Df and the waveform data Dw corresponding to the sounding style s1 are saved in the storage device 12, and the editing history of the feature sequence data Df and the waveform data Dw corresponding to the sounding style s2 are saved in the storage device 12. Therefore, the feature sequence data Df or the waveform data Dw corresponding to the sounding style s1, and the feature sequence data Df or the waveform data Dw corresponding to the sounding style s2, can be edited using trial and error in accordance with an instruction provided by the user.

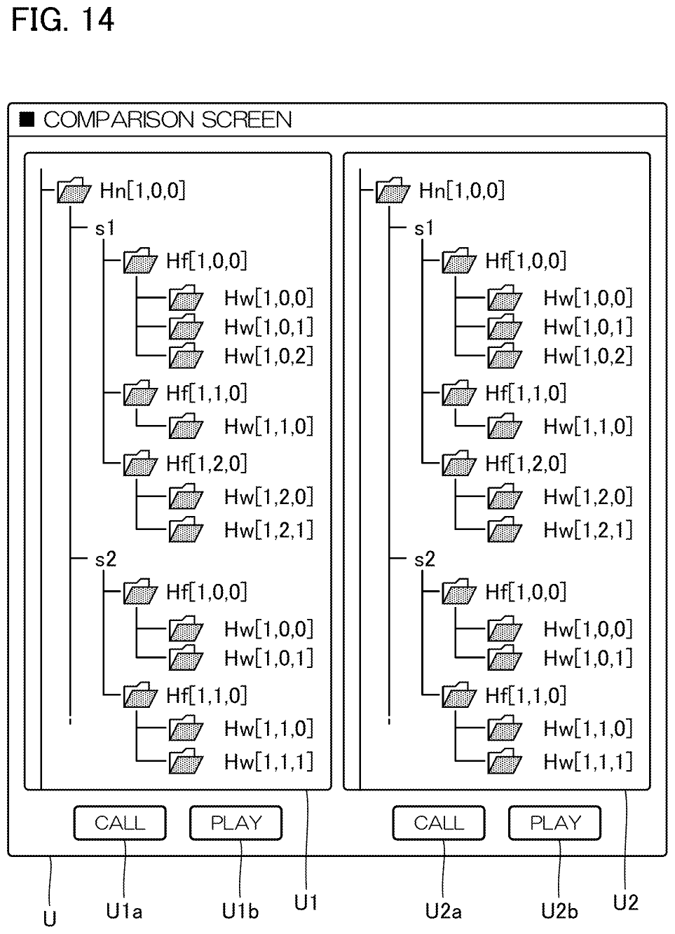

For example, in a case in which the user operates the operation device 15 to provide an instruction to compare different sounding styles s, the display controller 20 causes the display device 14 to display a comparison screen U as shown in FIG. 14. The comparison screen U includes a first area U1, an icon U1a (CALL), an icon U1b (PLAY), a second area U2, an icon U2a (CALL), and an icon U2b (PLAY).

In each of the first area U1 and the second area U2, hierarchical relations between the first history data Hn [Vn,Vf,Vw], the second history data Hf [Vn,Vf,Vw], and the third history data Hw [Vn,Vf,Vw] are displayed. The user can select desired history data H for each of the first area U1 and the second area U2 by operating the operation device 15. Specifically, the user can select desired history data H for each of the first area U1 and the second area U2 by designating the sounding style s and the version numbers (Vn,Vf,Vw).

In response to a selection of the icon U1a (CALL) by the user, the controller 11 acquires from the storage device 12 history data H selected in the first area U1, and causes the display device 14 to display an editing screen G that corresponds to the selected history data H. Specifically, in accordance with the sounding style s and the respective version numbers (Vn,Vf,Vw) of the history data H selected for the first area U1, the controller 11 acquires, from the history area, the first history data Hn [Vn=Xn,Vf=0,Vw=0] of the note sequence N, the second history data Hf [Vn=Xn,Vf=1,Vw=0] to Hf [Vn=Xn,Vf=Xf,Vw=0] of the feature sequence F corresponding to the sounding style s, and the third history data Hw [Vn=Xn,Vf=Xf,Vw=1] to Hw [Vn=Xn,Vf=Xf,Vw=Xw] of the waveform W corresponding to the sounding style s. The controller 11 generates the feature sequence data Df of a feature sequence F and the waveform data Dw of a waveform W that correspond to the version numbers (Vn,Vf,Vw) of the sounding style s, by using the history data H acquired from the history area. Then, the controller 11 causes the display device 14 to display an editing screen G including a note sequence indicated by the first history data Hn [Vn=Xn,Vf=0,Vw=0], a feature sequence F indicated by the feature sequence data Df, and a waveform W indicated by the waveform data Dw. When the user selects the icon U1b (PLAY), the controller 11 supplies the sound emitting device 13 with an audio signal Z corresponding to the waveform data Dw generated for the first area U1 in the above-described manner, to produce a synthesis sound.

Similarly, in response to a selection of the icon U2a (CALL) by the user, the controller 11 acquires from the storage device 12 the history data H selected for the second area U2, and causes the display device 14 to display an editing screen G corresponding to the selected history data H. Specifically, the controller 11 generates the feature sequence data Df and the waveform data Dw corresponding to the sounding style s and the respective version numbers (Vn,Vf,Vw) designated by the user for the second area U2 in the same manner as described above for the first area U1. Then, the controller 11 causes the display device 14 to display an editing screen G including a note sequence indicated by the first history data Hn [Vn=Xn,Vf=0,Vw=0], a feature sequence F indicated by the feature sequence data Df, and a waveform W indicated by the waveform data Dw. When the user selects the icon U2b (PLAY), the controller 11 supplies the sound emitting device 13 with an audio signal Z corresponding to the waveform data Dw generated for the second area U2 in the above-described manner, to produce a synthesis sound.

As will be apparent from the above example, the user can adjust the note sequence N, the feature sequence F, the waveform W, and the sounding style s while comparing the combination of the versions and the sounding style s selected from the first area U1 and the combination of the versions and the sounding style s selected from the second area U2.

### C: Third Embodiment

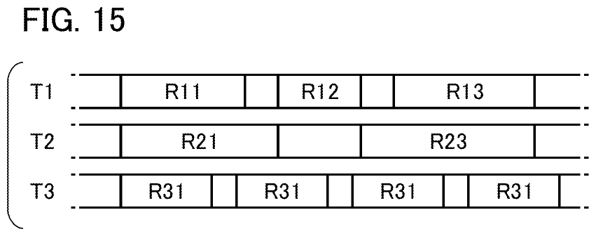

FIG. 15 is an explanatory diagram for sound synthesis in the third embodiment. In the third embodiment, sounds of a plurality of tracks T (T1, T2, . . . ) are synthesized in parallel to each other on a time axis. For example, in a case in which instrumental sounds of plural parts are synthesized in parallel, each part corresponds to each track T. In a case in which singing sounds of plural singing parts are synthesized in parallel, each singing part corresponds to each track T.

Each track T includes plural sections (hereinafter, “unit sections”) R arranged on the time axis in a manner that the unit sections do not overlap each other on the time axis. Each of the unit sections R is a section (region) including a note sequence N on the time axis. A note sequence N consisting of notes adjacent to one another on the time axis constitutes a unit section R. A time length of each unit section R is variable depending on a total number of the notes, each duration of the notes, or the like.

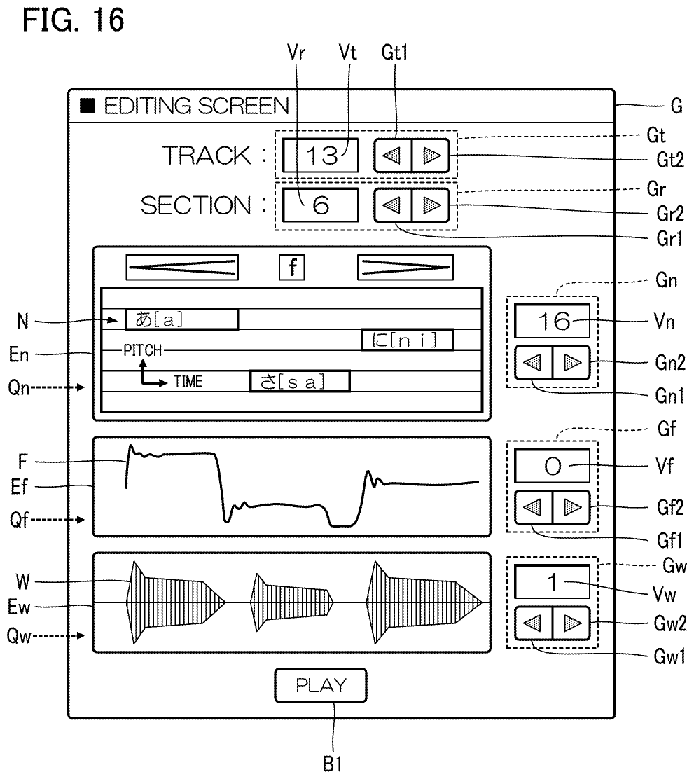

FIG. 16 is a schematic diagram of an editing screen G according to the third embodiment. One track T is selected by the user from among the tracks T and one unit section is selected by the user from among the unit sections of the one track T, information (note sequence N, feature sequence F, or waveform W) of the selected unit section R is displayed in the editing screen G. An area Gt and an area Gr are displayed in the editing screen G of the third embodiment in addition to the same elements as those of the first embodiment.

The area Gt is an area relating to a track T of the synthesis sound. Specifically, a track version number Vt, an icon Gt1, and an icon Gt2 are displayed in the area Gt. The track version number Vt indicates the version of the track T displayed in the editing screen G. The track version number Vt is incremented by 1, each time information (note sequence N, feature sequence F, or waveform W) of the track T displayed in the editing screen G is edited. The user can change the track version number Vt in the area Gt to a desired value by operating the operation device 15.

The icon Gt1 and the icon Gt2 are software buttons operable by the user using the operation device 15. The icon Gt1 is a control for operation by the user to provide an instruction to revert to information (note sequence N, feature sequence F, or waveform W) of the track T immediately before the previous edit (i.e., Undo). The icon Gt2 is a control for operation by the user to provide an instruction to re-execute the edit canceled by operating the icon Gt1 (i.e., Redo).

The area Gr is an area relating to a unit section R of the synthesis sound. Specifically, a section version number Vr, an icon Gr1, and an icon Gr2 are displayed in the area Gr. The section version number Vr indicates the version of the unit section R displayed in the editing screen G. The section version number Vr is incremented by 1, each time the information (note sequence N, feature sequence F, or waveform W) of the unit section R displayed in the editing screen G is edited. The user can change the section version number Vr in the area Gt to a desired value by operating the operation device 15.

The icon Gr1 and the icon Gr2 are software buttons operable by the user via the operation device 15. The icon Gr1 is a control for operation by the user to provide an instruction to revert to the information (note sequence N, feature sequence F, or waveform W) of the unit section R immediately before the previous edit (i.e., Undo). The icon Gr2 is a control operated by the user to provide an instruction to re-execute the edit canceled by operating the icon Gr1 (i.e., Redo).

The editing processes Sa (Sa1-Sa3) or the control processes Sb (Sb1-Sb3) are executed for each of the unit sections R of one track T displayed in the editing screen G. In the editing process Sa, each time any one of the note sequence N, the feature sequence F, and the waveform W is edited, the information manager 40 increments the track version number Vt by 1 and the section version number Vr by 1. Similarly, also in a case in which the user operates any icon (Gn1, Gf1, Gw1, Gn2, Gf2, or Gw2), the information manager 40 increments the track version number Vt by 1 and the section version number Vr by 1.

In the third embodiment, the same effects as those of the first embodiment are attainable. In addition, in the third embodiment, the user can provide an instruction to edit each of the note sequence data Dn and the feature sequence data Df and the waveform data Dw, while generating the waveform data Dw using trial and error for each of the unit sections R along the timeline.

### D: Modifications

Examples of modifications that can be made to the embodiments described above will now be described. Two or more aspects freely selected from the following examples may be combined in so far as they do not contradict each other.

(1) In each of the above described embodiments, the note sequence data Dn of the respective versions is saved in the first history data Hn [Vn,Vf,Vw] in the history area, but the composition of the first history data Hn [Vn,Vf,Vw] or the format of the first history data Hn [Vn,Vf,Vw] is not limited thereto. For example, the first history data Hn [Vn,Vf,Vw] saved may represent how the note sequence data Dn is edited (i.e., a series of edit instructions Qn). As will be apparent from the above explanation, the first history data Hn [Vn,Vf,Vw] is comprehensively expressed as data based on the edited note sequence N.

(2) In each of the above described embodiments, the second history data Hf [Vn,Vf,Vw] representing how the feature sequence data Df is edited (i.e., a series of edit instructions Qf) is saved in the history area, but the composition of the second history data Hf [Vn,Vf,Vw] or the format of the second history data Hf [Vn,Vf,Vw] is not limited thereto. For example, the feature sequence data Df edited in accordance with the edit instruction Qf may be saved in the history area as the second history data Hf [Vn,Vf,Vw]. As will be apparent from the above example, the second history data Hf [Vn,Vf,Vw] is comprehensively expressed as data based on the edited feature sequence data Df.

(3) In each of the above described embodiments, the third history data Hw [Vn,Vf,Vw] representing how the waveform data Dw is edited (i.e., a series of edit instructions Qw) is saved in the history area, but the composition of the third history data Hw [Vn,Vf,Vw] or the format of the third history data Hw [Vn,Vf,Vw] is not limited thereto. For example, the waveform data Dw edited in accordance with the edit instruction Qw may be saved in the history area as the third history data Hw [Vn,Vf,Vw]. As will be apparent from the above example, the third history data Hw [Vn,Vf,Vw] is comprehensively expressed as data based on the edited waveform data Dw.

(4) In each of the embodiments described above, the feature represented by the feature sequence F is in the form of the fundamental frequency of the synthesis sound. However, the feature represented by the feature sequence data Df is not limited to the fundamental frequency. For example, the feature may be in the form of a frequency spectrum (e.g., intensity spectrum) of the synthesis sound in the frequency domain or a sound pressure level on the time axis. In this case, time-series data representative of a series of frequency spectra or a series of sound pressure levels (i.e., feature sequence F) may be used as the feature sequence data Df. The feature sequence data Df is comprehensively expressed as time-series data representative of a series of features (feature sequence F) of the note sequence data Dn.

(5) In each of the above described embodiments, the second generator 34 generates the waveform data Dw from the note sequence data Dn and the feature sequence data Df. However, the second generator 34 may generate the waveform data Dw from the note sequence data Dn. Alternatively, the second generator 34 may generate the waveform data Dw from the feature sequence data Df. Thus, the second generator 34 is an element configured to generate the waveform data Dw from at least one of the note sequence data Dn or the waveform data Dw.

(6) In the second embodiment, the first generative model M1 outputs the feature sequence data Df in response to an input including the sounding style s. However, the first generator 32 may generate the feature sequence data Df corresponding to the sounding style s in another method. For example, the feature sequence data Df may be generated by selectively using one of plural first generative models M1 corresponding to different sounding styles s. A first generative model M1 corresponding to a sounding style s is established by machine learning using the corresponding first training data set prepared for the sounding style s. The first generator 32 generates the feature sequence data Df by inputting the note sequence data Dn, from among the prepared first generative models M1, to a first generative model M1 that corresponds to a sounding style s selected by the user.

Likewise, in the second embodiment, the second generative model M2 outputs the waveform data Dw in response to an input including the sounding style s. However, the second generator 34 may generate the waveform data Dw corresponding to the sounding style s by another method. For example, the waveform data Dw may be generated by selectively using one of plural second generative models M2 corresponding to different sounding styles s. A second generative model M2 corresponding to the respective sounding style s is established by machine learning using the corresponding second training data set prepared for the sounding style s. The second generator 34 generates the waveform data Dw by inputting input data Din including the note sequence data Dn and the feature sequence data Df, from among the prepared second generative models M2, to a second generative model M2 that corresponds to a sounding style s selected by the user.

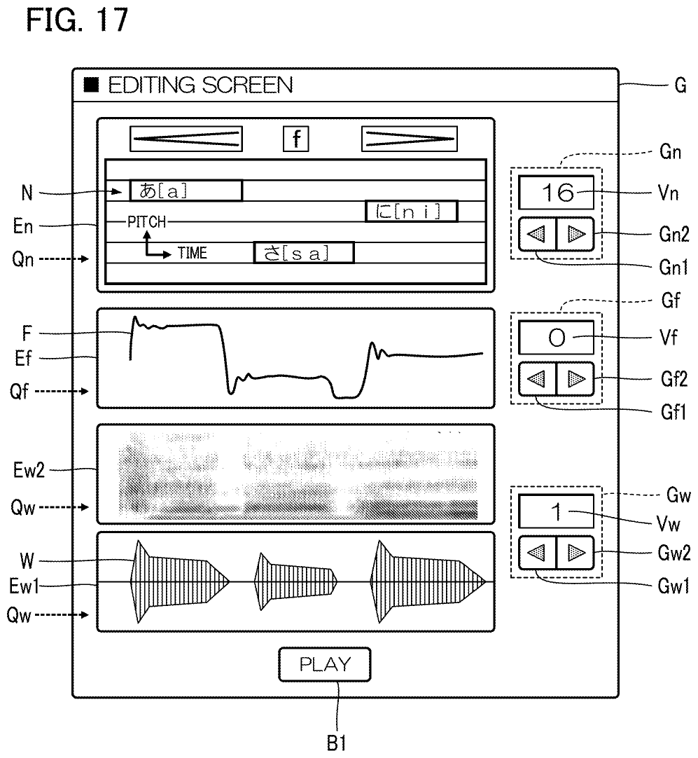

(7) In each of the above described embodiments, the waveform W of the audio signal Z is displayed in the editing area Ew of the editing screen G, but a series of the frequency spectra of the audio signal Z (i.e., spectrogram) may be displayed in the editing screen G together with the waveform W. For example, the editing screen G illustrated in FIG. 17 includes an editing area Ew1 and an editing area Ew2. In the editing area Ew1, the waveform W is displayed in substantially the same manner as the editing area Ew in each of the above described embodiments. In addition, the series of the frequency spectra of the audio signal Z is displayed in the editing area Ew2 in the present modification. In addition to an edit instruction Qw for editing the waveform in the editing area Ew1, the user can provide an edit instruction Qw to edit the frequency spectra in the editing area Ew2 by operating the operation device 15.

(8) The note sequence data Dn is time-series data representative of a note sequence N including notes on the time axis as elements. The feature sequence data Df is time-series data representative of a feature sequence F having features on the time axis as elements. The waveform data Dw is time-series data representative of a waveform W including samples on the time axis as elements. As will be apparent from the above examples, the note sequence data Dn, the feature sequence data Df, and the waveform data Dw are comprehensively expressed as time-series data representative of a time series of elements.

(9) In each of the above-described embodiments, a deep neural network is given as an example of the first generative model M1 and the second generative model M2, but the first generative model M1 and the second generative model M2 need not be a deep neural network. For example, a statistical estimation model of another architecture, such as a hidden Markov model (HMM), may be used as the first generative model M1 or the second generative model M2.

(10) In each of the above-described embodiments, sound corresponding to the note sequence N is synthesized. However, each of the above-described embodiments may be used in any situation in which time-series data representative of a series of elements is processed. For example, in each of the above-described embodiments, the upper layer corresponds to the note sequence N, the medium layer corresponds to the feature sequence F, and the lower layer corresponds to the waveform W. However, in a situation other than synthesis of sound, the respective layers may be configured as illustrated in the following.

For example, in automatic composition in which a melody is generated, a note sequence constituting the melody corresponds to the upper layer, a series of chords in the melody corresponds to the medium layer, and a note sequence of accompaniment harmonizing with the melody corresponds to the lower layer. Further, in speech synthesis in which speech corresponding to text is synthesized, the text corresponds to the upper layer, the pronunciation style of the speech corresponds to the medium layer, and the waveform of the speech corresponds to the lower layer. In signal processing of processing various types of signals, a waveform of a signal corresponds to the upper layer, a series of features of the signal corresponds to the medium layer, and a series of parameters relating to processing of the signal corresponds to the lower layer. In any of the embodiments illustrated above, the data of the upper layer is referred to as “upper data,” the data of the medium layer is referred to as “medium data,” and the data of the lower layer is referred to “lower data.” The lower data represents content for actual use by the user (e.g., the waveform W in each of the above described forms).

Each of notes constituting the note sequence N in each of the above-described embodiments and each of letters or characters constituting the text in speech synthesis are comprehensively expressed as a symbol indicative of sound. The note sequence N and the text (a string of letters or characters) are comprehensively expressed as a sequence of symbols in which a plurality of symbols are aligned in time series.

(11) As described above, the functions of the audio processing system illustrated above are realized by coordination between one or a plurality of processors that constitute the controller 11 and a program stored in the storage device 12. The program according to this disclosure may be provided in a form stored in a computer-readable recording medium and installed in the computer. The recording medium is, for example, a non-transitory recording medium, and an optical recording medium (optical disk), such as a CD-ROM is a good example, but any known type of recording medium, such as a semiconductor recording medium or a magnetic recording medium is also usable. A non-transitory recording medium includes any recording medium except for a transitory, propagating signal, and a volatile recording medium is not excluded. Further, in a configuration in which a distribution apparatus distributes the program via a communication network, the storage device 12 that stores the program in the distribution apparatus corresponds to the non-transitory recording medium described above.

### E: Appendices

As examples, the following aspects are derivable from the embodiments above.

The information processing method according to one aspect (aspect 1) of the present disclosure includes: editing first time-series data in accordance with a first instruction provided by a user; generating, based on the edited first time-series data, second time-series data representative of a series of features that corresponds to the edited first time-series data; editing the second time-series data in accordance with a second instruction provided by the user; in response to editing of the first time-series data, saving the edited first time-series data, as a new version of first time-series data in first history data, while incrementing a first version number indicative of a version of the edited first time-series data, and initializing a second version number indicative of a version of the second time-series data generated based on the edited first time-series data; in response to editing of the second time-series data, saving the edited second time-series data, as a new version of second time-series data in second history data, while incrementing the second version number and retaining the first version number; in response to a third instruction provided by the user, designating a first version number from among a plurality of values of the first version number and a second version number from among a plurality of values of the second version number according to the third instruction; and generating third time-series data representative of audio content corresponding to the first time-series data using (i) a first version of first time-series data in the first history data wherein the first version is indicated by the first version number of a first value, and (ii) a second version of second time-series data in the second history data wherein the second version is indicated by the first version number of the first value and the second version number of a second value.

In still another aspect, an information processing method includes: editing first time-series data in accordance with a first instruction provided by a user; generating, based on the edited first time-series data, second time-series data representative of a series of features that corresponds to the edited first time-series data; editing the second time-series data in accordance with a second instruction provided by the user; in response to editing of the first time-series data, saving the edited first time-series data in first history data; in response to editing of the second time-series data, saving the edited second time-series data in second history data; and generating third time-series data representative of content corresponding to the first time-series data using (i) a first version of first time-series data in the first history data, and (ii) a second version of second time-series data in the second history data.

According to the above aspect, since the first time-series data and the second time-series data are edited in accordance with instructions (the first instruction and the second instruction) provided by the user, it is possible to generate third time-series data that accurately reflects the instructions provided by the user. Based on editing of the first time-series data, the first version number is incremented, and the second version number is initialized, and based on editing of the second time-series data, the second version number is incremented while the first version number is retained. The third time-series data is generated using (i) the first history data corresponding to, from among the plurality of values of the first version number, the first setting value set in accordance with the instruction provided by the user, and (ii) the second history data corresponding to, from among the plurality of values of the second version number, the second setting value set in accordance with the instruction provided by the user. Therefore, the user can instruct editing of the first time-series data and the second time-series data while generating the third time-series data, using trial and error on different combinations of the first version number and the second version number.

In an example (aspect 2) of aspect 1, the first time-series data represents a note sequence, and the series of features represents a series of fundamental frequencies corresponding to the note sequence. According to this aspect, it is easy to edit the series of the fundamental frequencies for each of different note sequences or to compare the fundamental frequencies between the different note sequences.

In an example (aspect 3) of aspect 1 or aspect 2, the first history data represents a history of the edited first time-series data, and the second history data represents a history of the edited second time-series data. The second history data may represent a history of differences between the second time-series data before the editing of the second time-series data and the edited second time-series data after the editing. In the above aspect, since the second history data represents the difference between the second time-series data before being edited and the second time-series data after being edited (i.e., how the second time-series data is edited), the amount of the second history data can be significantly reduced as compared with a configuration in which the second history data is the entire second time-series data after being edited.

In an example (aspect 4) of any one of aspects 1 to 3, the third instruction designates a first value immediately before a first current value from among the plurality of values of the first version number as the first value, and a latest value among the plurality of values of the second version number under a version indicated by the first number as the second value. The third instruction may designate a value immediately before a second current value from among the plurality of values of the second version number as the second value, and retains a first current value of the first version number as the first value. According to this configuration, it is possible to check the third time-series data based on the first time-series data before execution of the immediately preceding edit (i.e., in a state in which the edit of the first time-series data has been canceled) or the third time-series data based on the second time-series data before the execution of the immediately preceding edit (i.e., in a state in which the edit the second time-series data has been canceled).

In an example (aspect 5) of any one of aspects 1 to 4, a track for generating the audio contents comprises a plurality of unit sections arranged along a time axis, and each unit section comprises the first time-series data, and the method is executed for each of the plurality of unit sections on the time axis. According to this aspect, it is possible to indicate editing of the first time-series data and the second time-series data while generating the third time-series data using trial and error for each of the unit sections on the time axis.

An information processing system according to another aspect of the present disclosure includes: one or more memories configured to store instructions; and one or more processors configured to execute the stored instructions to perform a method including: editing first time-series data in accordance with a first instruction provided by a user; generating, based on the edited first time-series data, second time-series data representative of a series of features that corresponds to the edited first time-series data; editing the second time-series data in accordance with a second instruction provided by the user; in response to editing of the first time-series data, saving the edited first time-series data, as a new version of first time-series data in first history data, while incrementing the first version number, and initializing the second version number; and in response to editing of the second time-series data, saving the edited second time-series data, as a new version of second time-series data in second history data while incrementing the second version number and retaining the first version number; in response to a third instruction provided by the user, designating a first version number from among a plurality of values of the first version number and a second version number from among a plurality of values of the second version number according to the third instruction; and generating third time-series data representative of audio content corresponding to the first time-series data using (i) a first version of first time-series data in the first history data wherein the first version is indicated by the first version number of a first value and (ii) a second version of second time-series data in the second history data wherein the second version is indicated by the first version number of the first value and the second version number of a second value.

A program according to still another aspect of the present disclosure causes a computer system to execute the above information processing method.

### DESCRIPTION OF REFERENCE SIGNS

100 information processing system
11 controller
12 storage device
13 sound emitting device
14 display device
15 operation device
20 display controller
30 edit processor
31 first editor
32 first generator
33 second editor
34 second generator
35 third editor
M first generative model
M2 second generative model

What is claimed:

1. A computer-implemented information processing method, comprising:
editing first time-series data in accordance with a first instruction provided by a user;
generating, based on the edited first time-series data, second time-series data representative of a series of features that corresponds to the edited first time-series data;
editing the second time-series data in accordance with a second instruction provided by the user;
in response to editing of the first time-series data, saving the edited first time-series data, as a new version of first time-series data in first history data, while incrementing a first version number indicative of a version of the edited first time-series data, and initializing a second version number indicative of a version of the second time-series data generated based on the edited first time-series data;
in response to editing of the second time-series data, saving the edited second time-series data, as a new version of second time-series data in second history data, while incrementing the second version number and retaining the first version number;
in response to a third instruction provided by the user, designating a first version number from among a plurality of values of the first version number and a second version number from among a plurality of values of the second version number according to the third instruction; and
generating third time-series data representative of audio content corresponding to the first time-series data using (i) a first version of first time-series data in the first history data wherein the first version is indicated by the first version number of a first value, and (ii) a second version of second time-series data in the second history data wherein the second version is indicated by the first version number of the first value and the second version number of a second value.

2. The information processing method according to claim 1, wherein:
the first time-series data represents a note sequence; and
the series of features represents a series of fundamental frequencies that corresponds to the note sequence.

3. The information processing method according to claim 1, wherein:
the first history data represents a history of the edited first time-series data; and
the second history data represents a history of the edited second time-series data.

4. The information processing method according to claim 1, wherein:
the first history data represents a history of the edited first time-series data; and
the second history data represents a history of differences between the second time-series data before the editing of the second time-series data and the edited second time-series data after the editing.

5. The information processing method according to claim 1 wherein:
the third instruction designates a first value immediately before a first current value among the plurality of values of the first version number as the first value, and a latest value among the plurality of values of the second version number under a version indicated by the first number as the second value.

6. The information processing method according to claim 1 wherein:
the third instruction designates a value immediately before a second current value among the plurality of values of the second version number as the second value, and retains a first current value of the first version number as the first value.

7. The information processing method according to claim 1, wherein:
a track for generating the audio contents comprises a plurality of unit sections arranged along a time axis, and each unit section comprises the first time-series data, and the method is executed for each of the plurality of unit sections on the time axis.

8. An information processing system comprising:
one or more memories configured to store instructions; and
one or more processors configured to execute the stored instructions to perform a method comprising:
editing first time-series data in accordance with a first instruction provided by a user;
generating, based on the edited first time-series data, second time-series data representative of a series of features that corresponds to the edited first time-series data;
editing the second time-series data in accordance with a second instruction provided by the user;
in response to editing of the first time-series data, saving the edited first time-series data, as a new version of first time-series data in first history data, while incrementing the first version number, and initializing the second version number;
in response to editing of the second time-series data, saving the edited second time-series data, as a new version of second time-series data in second history data while incrementing the second version number and retaining the first version number;
in response to a third instruction provided by the user, designating a first version number from among a plurality of values of the first version number and a second version number from among a plurality of values of the second version number according to the third instruction; and
generating third time-series data representative of audio content corresponding to the first time-series data using (i) a first version of first time-series data in the first history data wherein the first version is indicated by the first version number of a first value and (ii) a second version of second time-series data in the second history data wherein the second version is indicated by the first version number of the first value and the second version number of a second value.

9. The information processing system according to claim 8, wherein:
the first time-series data represents a note sequence; and
the series of features represents a series of fundamental frequencies that corresponds to the note sequence.

10. The information processing system according to claim 8, wherein:
the first history data represents a history of the edited first time-series data; and
the second history data represents a history of the edited second time-series data.

11. The information processing system according to claim 8, wherein:
the first history data represents a history of the edited first time-series data; and
the second history data represents a history of differences between the second time-series data before the editing of the second time-series data and the edited second time-series data after the editing.

12. The information processing system according to claim 8 wherein:
the third instruction designates a first value immediately before a first current value among the plurality of values of the first version number as the first value, and a latest value among the plurality of values of the second version number under a version indicated by the first number as the second value.

13. The information processing system according to claim 8 wherein:
the third instruction designates a value immediately before a second current value among the plurality of values of the second version number as the second value, and retains a first current value of the first version number as the first value.

14. The information processing system according to claim 8, wherein:
a track for generating the audio contents comprises a plurality of unit sections arranged along a time axis, and each unit section comprises the first time-series data, and the method is executed for each of the plurality of unit sections on the time axis.

15. A computer-implemented information processing method, comprising:
editing first time-series data in accordance with a first instruction provided by a user;
generating, based on the edited first time-series data, second time-series data representative of a series of features that corresponds to the edited first time-series data;
editing the second time-series data in accordance with a second instruction provided by the user;
in response to editing of the first time-series data, saving the edited first time-series data in first history data;
in response to editing of the second time-series data, saving the edited second time-series data in second history data; and
generating third time-series data representative of content corresponding to the first time-series data using (i) a first version of first time-series data in the first history data, and (ii) a second version of second time-series data in the second history data.
